(19) United States
(12) Patent Application Publication
(10) Pub. No.: US 2026/0347533 A1
(43) Pub. Date: Nov. 5, 2026

(54) CONDUCTIVE ELASTIC ROLLER AND METHOD OF MANUFACTURING SAME, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: YOSHITAKA SUZUMURA, Shizuoka (JP); KENJI TAKASHIMA, Kanagawa (JP); SEIJI TSURU, Shizuoka (JP); HIROAKI KOMATSU, Shizuoka (JP); MOTOTERU GOTO, Shizuoka (JP)

(21) Appl. No.: 19/648,587

(22) Filed: Apr. 15, 2026

(30) Foreign Application Priority Data
Apr. 22, 2025 (JP) 2025-070588

(51) Int. Cl. C08G 18/66; B32B 1/00; B32B 5/20; B32B 15/04; B32B 15/095; C08G 18/32; C08G 18/48; G03G 15/08; G03G 21/18

(52) U.S. Cl. CPC C08G 18/6688; B32B 1/00; B32B 5/20; B32B 15/046; B32B 15/095; C08G 18/3293; C08G 18/4837; G03G 15/0808; G03G 21/1814; G03G 21/1867; B32B 2266/0278; B32B 2266/104; B32B 2307/202

(57) ABSTRACT

A conductive elastic roller comprising a conductive substrate and a conductive elastic layer on the substrate, wherein the conductive elastic layer comprises polyurethane comprising a urethane bond and an ether bond, and an anion, the polyurethane comprises at least one selected from the group consisting of a specific cationic structure, the anion comprises at least one selected from the group consisting of (fluorosulfonyl)imide anion, (fluorosulfonate)imide anion, fluoroborate anion, fluorophosphate anion, dicyanamide anion, and thiocyanate anion, and a sum of a content of alkali metal and a content of alkaline-earth metal in the conductive elastic layer is 1.0×10⁻⁶ mol/g or less.

### BACKGROUND

### Field of the Technology

The present disclosure relates to a conductive elastic roller and a method of manufacturing the same, a process cartridge, and an electrophotographic image forming apparatus.

### Description of the Related Art

There are needs for further increasing a process speed of an electrophotographic image forming apparatus, compatibility with various media, achieving durability performance that enables long-term utilization, and compatibility with various environments. As conductive elastic rollers used in electrophotographic image forming apparatuses, a conductive elastic roller using electron conduction using a low-resistance filler to have conductivity, a conductive elastic roller using ion conduction using a binder or the like along with an ion compound, and a conductive elastic roller using such configurations together are widely known.

In many cases, an ion conduction-type conductive elastic roller is suitable for an electrophotographic image forming apparatus that performs high-definition image formation due to its excellent uniform resistance distribution. On the other hand, it is known that when a voltage is applied to the ion conduction-type conductive elastic roller, ions move inside the binder of the conductive elastic roller due to an influence of the voltage, and as a result, the resistance may significantly increase due to long-term application of the voltage.

Japanese Patent Laid-Open No. 2020-117578 discloses an ion conduction-type foam conductive elastic roller capable of stably expressing excellent performance with a small increase in electric resistance value even at the time of long-time operation in a high-temperature high-humidity environment.

Japanese Patent Laid-Open No. 2016-126332 discloses an electrophotographic member which has a charge providing ability that is not degraded even after long-term storage and utilization in a high-temperature high-humidity environment and which contributes to formation of an electrophotographic image with high quality.

Electrophotographic image forming apparatuses that are required to have increased process speeds and yet longer lifetimes are required to be able to stably form excellent electrophotographic images.

However, it has been found that it may be difficult for the ion conduction-type foam conductive elastic roller according to Japanese Patent Laid-Open No. 2020-117578 and the electrophotographic member according to Japanese Patent Laid-Open No. 2016-126332 to maintain a property of a low electric resistance in an initial operation stage over long-term utilization, especially at the time of a long-time operation in a low-temperature low-humidity environment.

In other words, in a case where an ion conduction-type conductive elastic roller is operated for a long time in a low-temperature low-humidity environment, it is difficult to curb an increase in electric resistance value, and it may be difficult to stably form an electrophotographic image with high quality.

### SUMMARY

The present disclosure directs to provide a conductive elastic roller that curbs an increase in an electric resistance value even at the time of a long-time operation in a low-temperature low-humidity environment and contributes to formation of an electrophotographic image with high quality. Moreover, the present disclosure directs to provide a method of manufacturing a conductive elastic roller that curbs an increase in an electric resistance value even at the time of a long-time operation in a low-temperature low-humidity environment and contributes to formation of an electrophotographic image with high quality. Furthermore, an object of the present disclosure is to provide a process cartridge and an electrophotographic image forming apparatus using the above-described conductive elastic roller and contributing to formation of an electrophotographic image with high quality.

According to at least one aspect of the present disclosure, there is provided a conductive elastic roller comprising:
a conductive substrate; and a conductive elastic layer on the substrate, wherein
the conductive elastic layer comprises polyurethane comprising a urethane bond and an ether bond, and an anion,
the polyurethane comprises at least one selected from the group consisting of a cationic structure represented by Structural Formula (1) below, a cationic structure represented by Structural Formula (2) below, and a cationic structure represented by Structural Formula (3) below,
the anion comprises at least one selected from the group consisting of (fluorosulfonyl)imide anion, (fluorosulfonate)imide anion, fluoroborate anion, fluorophosphate anion, dicyanamide anion, and thiocyanate anion, and
a sum of a content of alkali metal and a content of alkaline-earth metal in the conductive elastic layer is 1.0×10⁻⁶ mol/g or less:

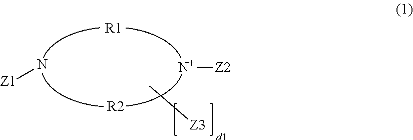

where in Structural Formula (1), R1 and R2 represent a hydrocarbon group needed to form a nitrogen-containing heteroaromatic 5-membered ring together with a nitrogen atom to which each of R1 and R2 is bonded, and d1 represents an integer which is 0 or 1. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, at least one of Z1 to Z3 is the structure represented by Structural Formula (Z101) below, the structure represented by Structural Formula (Z102) below, or the structure represented by Structural Formula (Z103) below:

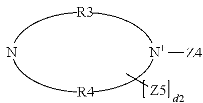

where in Structural Formula (2), R3 and R4 represent a hydrocarbon group needed to form a nitrogen-containing heteroaromatic 6-membered ring together with a nitrogen atom to which each of R3 and R4 is bonded, d2 represents an integer which is from 0 to 2, and Z5 may be the same or differ when d2 is 2. Z4 and Z5 each independently represent the structure represented by Structural Formula (Z101) below, the structure represented by Structural Formula (Z102), the structure represented by Structural Formula (Z103), a hydrogen atom, or a hydrocarbon group having 1 to 4 carbon atoms. However, at least one of Z4 and Z5 is the structure represented by Structural Formula (Z101) below, the structure represented by Structural Formula (Z102) below, or the structure represented by Structural Formula (Z103) below:

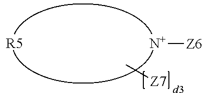

where in Structural Formula (3), R5 represents a hydrocarbon group needed to form a nitrogen-containing heteroaromatic ring together with a nitrogen atom to which R5 is bonded, and d3 represents an integer which is 0 or 1. Z6 and Z7 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, at least one of Z6 and Z7 is the structure represented by Structural Formula (Z101) below, the structure represented by Structural Formula (Z102) below, or the structure represented by Structural Formula (Z103) below:

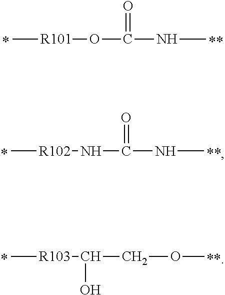

where in Structural Formulas (Z101), (Z102), and (Z103), R101, R102, and R103 each independently represent a linear or branched divalent hydrocarbon group. The symbol “*” represents a bonding portion with a nitrogen atom or a carbon atom constituting the nitrogen-containing heteroaromatic 5-membered ring of Structural Formula (1), a bonding portion with a nitrogen atom or a carbon atom constituting the nitrogen-containing heteroaromatic 6-membered ring of Structural Formula (2), or a bonding portion with a nitrogen atom or a carbon atom constituting the nitrogen-containing heteroaromatic ring of Structural Formula (3). The symbol “**” represents a bonding portion with a carbon atom in a polymer chain of the polyurethane.

According to at least one aspect of the present disclosure, there is provided a method of manufacturing a conductive elastic roller,
the conductive elastic roller comprising a conductive substrate and a conductive elastic layer on the substrate,
the conductive elastic layer comprising polyurethane having a urethane bond and an ether bond, and an anion,
the polyurethane comprising a cationic structure represented by the above Structural Formula (1),
the anion comprising at least one selected from the group consisting of bis(fluorosulfonyl)imide anion, and bis(fluorosulfonate)imide anion,
a sum of a content of alkali metal and a content of alkaline-earth metal in the conductive elastic layer being 1.0×10⁻⁶ mol/g or less,
the manufacturing method comprising:
a step of pouring an elastic layer forming material into a mold with the substrate disposed therein; and
a step of heating the mold and curing the elastic layer forming material to form the conductive elastic layer, wherein
the elastic layer forming material comprises at least a liquid composition comprising an ion compound represented by Structural Formula (7) below, polyol, and polyisocyanate,
a content of the ion compound in the liquid composition is 95% by mass or more and less than 100% by mass,
a content of alkali metal and alkaline-earth metal in the liquid composition is 30000 ppm or less, and
a viscosity of the liquid composition at 23 °C is 1 to 1000 mPa·s:

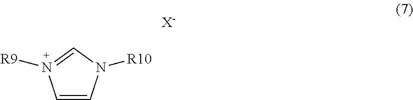

where in Structural Formula (7), R9 and R10 each independently represent an alkyl group having 1 to 4 carbon atoms, a hydroxyalkyl group having 1 to 4 carbon atoms, or a hydrogen atom. At least one of R9 and R10 is a hydroxyalkyl group having 1 to 4 carbon atoms. X⁻ represents an anion.

According to at least one aspect of the present disclosure, there is provided a process cartridge configured to be attachable to and detachable from a main body of an electrophotographic image forming apparatus, the process cartridge comprising:
a contact member that is electrically connected to an electrical contact point of the main body when the process cartridge is attached to the main body;
a developing roller; and a developer supply roller that supplies a developer to the developing roller, wherein
the process cartridge is configured such that a voltage is able to be applied between the developing roller and the developer supply roller through electrical connection to the main body, and
the developer supply roller is the above conductive elastic roller.

According to at least one aspect of the present disclosure, there is provided an electrophotographic image forming apparatus comprising at least:
an electrophotographic photosensitive member;
a developing roller that is disposed in contact with the electrophotographic photosensitive member; and
a developer supply roller that supplies a developer to the developing roller, wherein
the developer supply roller is the above conductive elastic roller.

According to at least one aspect of the present disclosure, it is possible to provide a conductive elastic roller that curbs an increase in electric resistance value even at the time of a long-time operation in a low-temperature low-humidity environment and contributes to formation of an electrophotographic image with high quality. Also, according to at least one aspect of the present disclosure, it is possible to provide a method of manufacturing a conductive elastic roller that curbs an increase in electric resistance value even at the time of a long-time operation in a low-temperature low-humidity environment and contributes to formation of an electrophotographic image with high quality. Furthermore, according to at least one aspect of the present disclosure, it is possible to provide a process cartridge and an electrophotographic image forming apparatus using the above-described conductive elastic roller and contributing to formation of an electrophotographic image with high quality.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of a conductive elastic roller.

FIG. 2 is a schematic configuration diagram of an electrophotographic image forming apparatus.

FIG. 3 is a schematic configuration diagram of a process cartridge.

FIGS. 4A and 4B are schematic configuration diagrams of a jig for evaluating a resistance value of the conductive elastic roller.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ. Here, when XX is a group, a plurality of XXs may be selected, and the same applies to YY and ZZ.

In an ion conduction-type conductive elastic roller, an ion compound moves inside a binder such as polyurethane due to an influence of an applied voltage at the time of a long-time operation, and an electric resistance value is likely to increase. In an ion conduction-type conductive elastic roller with a low electric resistance value, a moving speed of an ion compound in a binder is likely to increase, in particular, and an electric resistance value is more likely to increase. It is more difficult to curb an increase in electric resistance value at the time of a long-time operation in a low-temperature low-humidity environment in which the electric resistance value is likely to increase, in particular.

As a result of investigations made by the present inventors, it has been found to be important to satisfy the following requirements (1) and (2) in order for the ion conduction-type conductive elastic roller to maintain a low electric resistance value over long-time utilization.
(1) To increase dissociation rate between an anion and a cation constituting an ion compound and increase the amounts of an anion and a cation in a binder.
(2) To restrict migration of the anion in the binder.

The amount of anion as a carrier that carries an electron in the binder of the conductive elastic layer increases by satisfying the requirement (1), and it is thus possible to reduce an initial electric resistance value.

On the other hand, in a case where an anion is in a state where it can easily move in the binder, the amount of anion capable of transporting electrons is likely to decrease with time, and the electric resistance value is likely to increase with elapse of time. Therefore, it is important to restrict migration of the anion in the binder. In other words, it is possible to curb an increase in electric resistance value after long-time utilization by satisfying the requirement (2).

For the reasons described above, it was found to be possible to maintain the property of the low electric resistance value over a long period of time even at the time of a long-time operation of the ion conduction-type conductive elastic roller by satisfying the requirements (1) and (2).

Hereinafter, an embodiment for implementing the present disclosure will be specifically described.

The conductive elastic roller comprises a conductive substrate and a conductive elastic layer on the substrate. The conductive elastic layer comprises polyurethane comprising a urethane bond and an ether bond and an anion.

The conductive elastic layer uses the polyurethane comprising a urethane bond and an ether bond as a binder. The polyurethane comprising a urethane bond and an ether bond has excellent elasticity. Furthermore, polymer chains in polyurethane form a hydrogen bond by the ether bond being comprised. The hydrogen bond can restrict migration of the anion. As a result, the above requirement (2) can be satisfied.

The polyurethane comprised in the conductive elastic layer has at least one selected from the group consisting of a cationic structure represented by Structural Formula (1) above, a cationic structure represented by Structural Formula (2) above, and a cationic structure represented by Structural Formula (3) above.

In the cationic structure represented by Structural Formula (1), the cationic structure represented by Structural Formula (2), and the cationic structure represented by Structural Formula (3), the electron density of the positive charge that the cationic structures have is low due to the electron conjugation of a nitrogen-containing aromatic ring. Therefore, ion bonding by the negative charge that the anion has and the positive charge of the cationic structures is likely to become weak, and it is possible to increase the dissociation rate between the anion and the cationic structures and to satisfy the above requirement (1). As a result, an anion and a cation in charge of electrical conductivity become likely to move in a dissociated state, conductivity is unlikely to decrease even at the time of a long-time operation, and it is possible to curb an increase in electric resistance value.

The anion comprised in the conductive elastic layer comprises at least one selected from the group consisting of (fluorosulfonyl)imide anion, (fluorosulfonate)imide anion, fluoroborate anion, fluorophosphate anion, dicyanamide anion, and thiocyanate anion.

These anions have a relatively large difference in solubility parameter from that of the polyurethane comprising a urethane bond and an ether bond described above. Although the anion moves in the polyurethane as a binder due to an influence of a voltage when the voltage is applied to the conductive elastic roller, it is possible to restrict the migration of the anion even at the time of a long-time operation by the difference in solubility parameters from that of the polyurethane being relatively large. As a result, it is possible to satisfy the above requirement (2).

Furthermore, the sum of the content of alkali metal and the content of alkaline-earth metal in the conductive elastic layer is 1.0×10⁻⁶ mol/g or less. It is possible to maintain the property of the low electric resistance value of the conductive elastic roller over long-time utilization by satisfying the range.

According to investigations made by the present inventors, alkali metal and alkaline-earth metal tend to inhibit formation of a hydrogen bond between polymer chains of the polyurethane by coordinating with the ether bond that the polyurethane has. It is thus presumed that in a case where the content of alkali metal and alkaline-earth metal in the conductive elastic layer is large, the anion is likely to freely move in the binder when a voltage is applied to the conductive elastic roller, and it becomes difficult to maintain a low electric resistance value at the time of a long-time operation.

It is possible to limit the migration of the anion in polyurethane within an appropriate range without inhibiting formation of a hydrogen bond between polymer chains of polyurethane having an ether bond by the sum of the content of alkali metal and the content of alkaline-earth metal in the conductive elastic layer being 1.0×10⁻⁶ mol/g or less. As a result, it is possible to satisfy the above requirement (2).

In this manner, the configuration of the present disclosure can achieve the requirements (1) and (2) described above at the same time. Specifically, it is possible to achieve a state where the cation and the anion are unlikely to be dissociated and a state where the anion is unlikely to move in the binder at the same time by satisfying the requirements (1) and (2) described above. Therefore, it is possible to curb an increase in electric resistance value of the conductive elastic roller and to stably maintain the low electric resistance value in an initial stage of utilization even at the time of a long-time operation in a low-temperature low-humidity environment in which the electric resistance value is likely to increase, and it is thus possible to obtain a conductive elastic roller capable of forming an image with high quality.

### Conductive Elastic Roller

The conductive elastic roller comprises a conductive substrate and a conductive elastic layer on the substrate.

### Foam Conductive Elastic Roller

The conductive elastic layer may be a foam conductive elastic layer which is a foam. The conductive elastic roller may be a foam conductive elastic roller that comprises a conductive substrate and a foam conductive elastic layer on the substrate.

A configuration of the conductive elastic roller will be described.

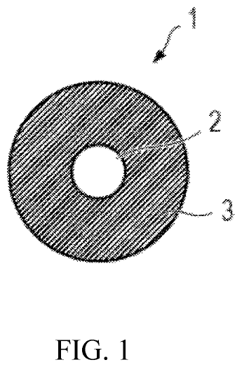

One example of the conductive elastic roller is illustrated in FIG. 1. A conductive elastic roller 1 illustrated in FIG. 1 comprises a conductive substrate 2 and a conductive elastic layer 3 provided on the outer periphery of the substrate 2.

Note that the layer configuration of the conductive elastic roller 1 is not limited to a configuration in which the conductive elastic layer 3 is present on the outermost surface of the conductive elastic roller 1. As the conductive elastic roller 1, a conductive elastic roller that further has a surface layer on the substrate 2 and the conductive elastic layer 3 with conductivity provided on the outer periphery of the substrate 2, a conductive elastic roller that further has an elastic layer or the like between the substrate 2 and the conductive elastic layer 3, and the like can be exemplified.

The conductive elastic roller comprising the conductive elastic layer can be suitably used as a charging roller, a developing roller, a toner supply roller, or the like. The conductive elastic roller can be particularly suitably used as a toner supply roller. In a case where the conductive elastic layer is a foam conductive elastic layer, the foam conductive elastic roller can be particularly suitably used as a toner supply roller.

Hereinafter, a configuration of the conductive elastic roller according to an aspect of the present disclosure will be described in detail.

### Substrate

The substrate 2 is conductive and functions as a support member of the conductive elastic roller and an electrode. The substrate 2 is made of, for example, a conductive material such as metal or an alloy such as aluminum, a copper alloy, or stainless steel; iron plated with chromium or nickel; or a synthetic resin with conductivity. The substrate 2 is, for example, stainless steel. The substrate 2 preferably has a solid columnar shape or a hollow cylindrical shape.

The conductive elastic layer comprises polyurethane comprising a urethane bond and an ether bond and an anion.

The polyurethane has at least one cationic structure selected from the group consisting of structures represented by Structural Formulas (1) to (3).

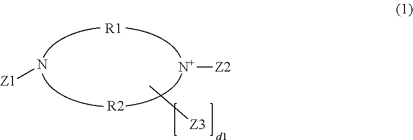

In Structural Formula (1), R1 and R2 represent a hydrocarbon group needed to form a nitrogen-containing heteroaromatic 5-membered ring together with a nitrogen atom to which each of R1 and R2 is bonded, and d1 represents an integer which is 0 or 1. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, at least one of Z1 to Z3 is the structure represented by Structural Formula (Z101) below, the structure represented by Structural Formula (Z102) below, or the structure represented by Structural Formula (Z103) below.

The hydrocarbon group having 1 to 4 carbon atoms is preferably an alkyl group, is more preferably an alkyl group having 1 to 2 carbon atoms, and is further preferably an alkyl group having two carbon atoms. The nitrogen-containing heterocyclic structure of Structural Formula (1) is preferably imidazolium cation, for example.

In Structural Formula (2), Z1 or Z2 is preferably a structure represented by Structural Formula (Z101) below, the structure represented by Structural Formula (Z102) below, or the structure represented by Structural Formula (Z103) below. Also, both Z1 and Z2 are preferably the structure represented by Structural Formula (Z101) below, the structure represented by Structural Formula (Z102) below, or the structure represented by Structural Formula (Z103) below. Both Z1 and Z2 are preferably the structure represented by Structural Formula (Z101) below.

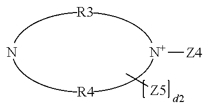

In Structural Formula (2), R3 and R4 represent a hydrocarbon group needed to form a nitrogen-containing heteroaromatic 6-membered ring together with a nitrogen atom to which each of R3 and R4 is bonded, d2 represents an integer which is from 0 to 2, and Z5 may be the same or differ when d2 is 2. Z4 and Z5 each independently represent the structure represented by Structural Formula (Z101) below, the structure represented by Structural Formula (Z102), the structure represented by Structural Formula (Z103), a hydrogen atom, or a hydrocarbon group having 1 to 4 carbon atoms. However, at least one of Z4 and Z5 is the structure represented by Structural Formula (Z101) below, the structure represented by Structural Formula (Z102) below, or the structure represented by Structural Formula (Z103) below.

The hydrocarbon group having 1 to 4 carbon atoms is preferably an alkyl group. The nitrogen-containing heteroaromatic structure of Structural Formula (2) is preferably pyrazinium cation or pyrimidinium cation, for example.

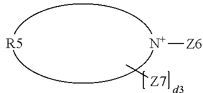

In Structural Formula (3), R5 represents a hydrocarbon group needed to form a nitrogen-containing heteroaromatic ring together with a nitrogen atom to which R5 is bonded, and d3 represents an integer which is 0 or 1. Z6 and Z7 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, at least one of Z6 and Z7 is the structure represented by Structural Formula (Z101) below, the structure represented by Structural Formula (Z102) below, or the structure represented by Structural Formula (Z103) below.

The hydrocarbon group having 1 to 4 carbon atoms is preferably an alkyl group. The nitrogen-containing heteroaromatic structure of Structural Formula (3) is preferably pyridinium cation, for example.

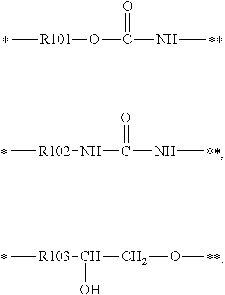

In Structural Formulas (Z101), (Z102), and (Z103), R101, R102, and R103 each independently represent a linear or branched divalent hydrocarbon group. The symbol “*” represents a bonding portion with a nitrogen atom or a carbon atom constituting the nitrogen-containing heteroaromatic 5-membered ring of Structural Formula (1), a bonding portion with a nitrogen atom or a carbon atom constituting the nitrogen-containing heteroaromatic 6-membered ring of Structural Formula (2), or a bonding portion with a nitrogen atom or a carbon atom constituting the nitrogen-containing heteroaromatic ring of Structural Formula (3). The symbol “**” represents a bonding portion with a carbon atom in a polymer chain of the polyurethane.

The divalent hydrocarbon group is preferably a linear or branched alkylene group having 1 to 8 carbon atoms, is more preferably an alkylene group having 1 to 4 carbon atoms, and is further preferably an alkylene group having 1 to 2 carbon atoms. R101, R102 and R103 are preferably —CH₂—, —C₂H₄—, or —C₄H₈— and are more preferably —C₂H₄—.

### Concerning Relationship Between Cationic Structure and Dissociation Rate

In a case where the cationic structure that the polyurethane has is a structure that does not have a nitrogen-containing aromatic ring such as quaternary ammonium cation or pyrrolidinium cation, for example, a positive charge is likely to be localized on a nitrogen atom, and the anion and the cation are unlikely to be dissociated.

On the other hand, in a case where the cationic structure that the polyurethane has is a cationic skeleton including a cationic nitrogen-containing heteroaromatic ring as represented by Structural Formulas (1) to (3), a positive charge is distributed mainly to the nitrogen atom and is also distributed to other atoms on the aromatic ring due to electron conjugation of the nitrogen-containing aromatic ring. As a result, electrostatic interaction between the cation and the anion decreases, the ion bonding is weakened, and the dissociation rate between the cation and the anion thus increases.

In the present disclosure, the dissociation rate between the cation and the anion is increased by the polyurethane having the cationic structure including the nitrogen-containing heteroaromatic ring, which is at least one selected from the structures represented by Structural Formulas (1) to (3) above. As a result, it is possible to increase the amounts of cation and anion that can move in the polyurethane and to curb an increase in electric resistance value of the conductive elastic roller.

### Polyurethane

The polyurethane comprised in the conductive elastic layer 3 of the conductive elastic roller has at least one cation structure selected from the group consisting of the structures represented by Structural Formulas (1) to (3). The polyurethane comprises a nitrogen-containing heteroaromatic ring structure. The polyurethane functions as a bearing member of the anion in charge of electrical conductivity. Note that the conductive elastic layer 3 may comprise a resin that is different from the resin having the cationic structure.

The polyurethane having the cationic structure described above is, for example, a reaction product of a compound comprising a nitrogen-containing heteroaromatic ring structure and a polyurethane raw material mixture forming the polyurethane. The polyurethane raw material mixture comprises, for example, a compound other than the compound comprising the nitrogen-containing heteroaromatic ring structure (hereinafter, also referred to as a “nitrogen-containing heteroaromatic ring compound”), preferably, polyol and polyisocyanate. The nitrogen-containing heteroaromatic ring compound is preferably an ionic compound comprising the nitrogen-containing heteroaromatic ring structure, which is a cation, and an anion.

The nitrogen-containing heteroaromatic ring compound preferably has at least one functional group including a hydroxyl group, an amino group, or a glycidyl group. The hydroxyl group or the amino group reacts with an isocyanate group of the compound comprising the cationic structure to form a bond. Therefore, the nitrogen-containing heteroaromatic ring structure can be introduced into the urethane molecular structure from, for example, a reaction between the nitrogen-containing heteroaromatic ring compound and the polyisocyanate. The glycidyl group reacts with a hydroxyl group of the nitrogen-containing heteroaromatic ring compound to form a bond. Therefore, the nitrogen-containing heteroaromatic ring structure can be introduced into the urethane molecular structure from a reaction between the nitrogen-containing heteroaromatic ring compound and the polyol.

### Cationic Structure

The compound comprising the nitrogen-containing heteroaromatic ring structure is a compound in which in the structure represented by Structural Formula (1) above, the structure represented by Structural Formula (2) above, and the structure represented by Structural Formula (3) above, the part to which the structure represented by Structural Formula (Z101), the structure represented by Structural Formula (Z102), or the structure represented by Structural Formula (Z103) is bonded is substituted with a functional group including a hydroxyl group, an amino group, or a glycidyl group.

The ion compound is a precursor of at least one cationic structure selected from the group consisting of the structures represented by Structural Formulas (1) to (3) above and can form the cationic structure by reacting with an isocyanate group or a hydroxyl group and being introduced into polyurethane, for example. Hereinafter, each of the structures represented by Structural Formulas (1) to (3) will be described.

The structure represented by Structural Formula (1) can be formed by a nitrogen-containing heteroaromatic 5-membered ring cation having at least one functional group including a hydroxyl group, an amino group, or a glycidyl group and further including two nitrogen atoms.

In a case where the structure represented by Structural Formula (1) is a nitrogen-containing heteroaromatic 5-membered ring cation having at least one functional group including a hydroxyl group, the following can be said. In other words, a structure having at least one structure represented by Structural Formula (Z101) can be obtained by causing an ion compound comprising the cation to react with an isocyanate group.

In a case where the structure represented by Structural Formula (1) is a nitrogen-containing heteroaromatic 5-membered ring cation having at least one functional group including an amino group, the following can be said. In other words, a structure having at least one structure represented by Structural Formula (Z102) can be obtained by causing an ion compound comprising the cation to react with an isocyanate group.

In a case where the structure represented by Structural Formula (1) is a nitrogen-containing heteroaromatic 5-membered ring cation having at least one functional group including a glycidyl group, the following can be said. In other words, a structure having at least one structure represented by Structural Formula (Z103) can be obtained by causing an ion compound comprising the cation to react with a hydroxyl group.

The nitrogen-containing heteroaromatic 5-membered ring in Structural Formula (1) is preferably imidazolium. Examples of the structure there of include a structure having an imidazoline ring represented by Structural Formula (4) below.

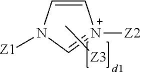

In Structural Formula (4), d1 represents an integer which is 0 or 1. Z1 to Z3 each independently represent the structure represented by Structural Formula (Z101), the structure represented by Structural Formula (Z102), the structure represented by Structural Formula (Z103), a hydrogen atom, or a hydrocarbon group having 1 to 4 (preferably 1 to 2, more preferably 1) carbon atoms. However, at least one of Z1 to Z3 is the structure represented by Structural Formula (Z101), the structure represented by Structural Formula (Z102), or the structure represented by Structural Formula (Z103).

Examples of the ion compound capable of forming the structure represented by Structural Formula (1) include the following cations having an imidazoline ring structure and a hydroxyl group:

1-methyl-3-hydroxymethyl imidazolium cation, 1-methyl-3-(2-hydroxyethyl)imidazolium cation, 1-methyl-3-(3-hydroxypropyl)imidazolium cation, 1-methyl-3-(4-hydroxybutyl)imidazolium cation, 1-methyl-3-(6-hydroxyhexyl)imidazolium cation, 1-methyl-3-(8-hydroxyoctyl)imidazolium cation, 1-ethyl-3-(2-hydroxyethyl)imidazolium cation, 1-n-butyl-3-(2-hydroxyethyl)imidazolium cation, 1,3-dimethyl-2-(2-hydroxyethyl)imidazolium cation, 1,3-dimethyl-2-(4-hydroxybutyl)imidazolium cation, and 1,3-dimethyl-4-(2-hydroxyethyl)imidazolium cation;

1,3-bis(hydroxymethyl)imidazolium cation, 1,3-bis(2-hydroxyethyl)imidazolium cation, 2-methyl-1,3-bis(hydroxymethyl)imidazolium cation, 2-methyl-1,3-bis(2-hydroxyethyl)imidazolium cation, 4-methyl-1,3-bis(2-hydroxyethyl)imidazolium cation, 2-ethyl-1,3-bis(2-hydroxyethyl)imidazolium cation, 4-ethyl-1,3-bis(2-hydroxyethyl)imidazolium cation, 2-n-butyl-1,3-bis(2-hydroxyethyl)imidazolium cation, 4-n-butyl-1,3-bis(2-hydroxyethyl)imidazolium cation, 1,3-bis(3-hydroxypropyl)imidazolium cation, 1,3-bis(4-hydroxybutyl)imidazolium cation, 1,3-bis(6-hydroxyhexyl)imidazolium cation, 1,3-bis(8-hydroxyoctyl)imidazolium cation, 1-methyl-2,3-bis(2-hydroxyethyl)imidazolium cation, 1-methyl-3,4-bis(2-hydroxyethyl)imidazolium cation, 1-methyl-3,5-bis(2-hydroxyethyl)imidazolium cation;

1,2,3-tris(hydroxymethyl)imidazolium cation, 1,2,3-tris(2-hydroxyethyl)imidazolium cation, 1,2,3-tris(3-hydroxypropyl)imidazolium cation, 1,2,3-tris(4-hydroxybutyl)imidazolium cation, 1,2,3-tris(6-hydroxyhexyl)imidazolium cation, 1,2,3-tris(8-hydroxyoctyl)imidazolium cation, 1,3,4-tris(2-hydroxyethyl)imidazolium cation, 1,3,4-tris(3-hydroxypropyl)imidazolium cation, 1,3,4-tris(4-hydroxybutyl)imidazolium cation, 1,3,4-tris(6-hydroxyhexyl)imidazolium cation, and 1,3,4-tris(8-hydroxyoctyl)imidazolium cation; and derivatives thereof.

A cation having an imidazoline ring structure and having at least one functional group including an amino group or a glycidyl group is not particularly limited. Examples thereof include cations having a structure in which a hydroxyl group of the cation having an imidazoline ring structure and a hydroxyl group exemplified above has been substituted with a functional group comprising an amino group or a glycidyl group.

The structure represented by Structural Formula (2) can be formed by a nitrogen-containing heteroaromatic 6-membered ring cation having at least one functional group including a hydroxyl group, an amino group, or a glycidyl group and further including two nitrogen atoms.

In a case where the structure represented by Structural Formula (2) is a nitrogen-containing heteroaromatic 6-membered ring cation having at least one functional group including a hydroxyl group, the following can be said. In other words, a structure having at least one structure represented by Structural Formula (Z101) can be obtained by causing an ion compound comprising the cation to react with an isocyanate group.

In a case where the structure represented by Structural Formula (2) is a nitrogen-containing heteroaromatic 6-membered ring cation having at least one functional group including an amino group, the following can be said. In other words, a structure having at least one structure represented by Structural Formula (Z102) can be obtained by causing an ion compound comprising the cation to react with an isocyanate group.

In a case where the structure represented by Structural Formula (2) is a nitrogen-containing heteroaromatic 6-membered ring cation having at least one functional group including a glycidyl group, the following can be said. In other words, a structure having at least one structure represented by Structural Formula (Z103) can be obtained by causing an ion compound comprising the cation to react with a hydroxyl group.

Examples of the nitrogen-containing heteroaromatic 6-membered ring in Structural Formula (2) include a pyrimidine ring and a pyrazine ring. Examples of an ion compound capable of forming the structure represented by Structural Formula (2) include the following cations having a pyrimidine ring structure and having a hydroxyl group.

1,4-bis(2-hydroxyethyl)pyrimidinium cation, 1,5-bis(3-hydroxypropyl)pyrimidinium cation, 1-(4-hydroxybutyl)-4-(2-hydroxyethyl)pyrimidinium cation, 1,4-bis(2-hydroxyethyl)-2-methylpyrimidinium cation; and derivatives thereof.

The cations having a pyrimidine ring structure and having at least one functional group comprising an amino group or glycidyl group are not particularly limited. Examples thereof include cations having a structure in which a hydroxyl group of the cation having a pyrimidine ring structure and a hydroxyl group exemplified above has been substituted with a functional group comprising an amino group or a glycidyl group.

The structure represented by Structural Formula (3) can be formed by a nitrogen-containing heteroaromatic ring cation having at least one functional group including a hydroxyl group, an amino group, or a glycidyl group and further having one nitrogen atom.

In a case where the structure represented by Structural Formula (3) is a nitrogen-containing heteroaromatic ring cation having at least one functional group including a hydroxyl group, the following can be said. In other words, a structure having at least one structure represented by Structural Formula (Z101) can be obtained by causing an ion compound comprising the cation to react with an isocyanate group.

In a case where the structure indicated by the Structural Formula (3) is a nitrogen-containing heteroaromatic ring cation having at least one functional group comprising an amino group, the following can be said. That is, a structure having at least one structure represented by the Structural Formula (Z102) can be obtained by reacting an ion compound comprising the cation and an isocyanate group.

In a case where the structure indicated by the Structural Formula (3) is a nitrogen-containing heteroaromatic ring cation having at least one functional group comprising a glycidyl group, the following can be said. That is, a structure having at least one structure represented by the Structural Formula (Z103) can be obtained by reacting an ion compound comprising the cation and a hydroxyl group.

Examples of the nitrogen-containing heteroaromatic ring in Structural Formula (3) include a pyrrole ring, a pyridine ring, and an azepine ring. Among these, a pyridine ring is preferably used, and the structure represented by Structural Formula (3) is preferably a structure represented by Structural Formula (5) below.

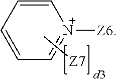

In Structural Formula (5), d3 represents an integer which is 0 or 1. Z6 and Z7 each independently represent the structure represented by Structural Formula (Z101) above, the structure represented by Structural Formula (Z102) above, the structure represented by Structural Formula (Z103) above, a hydrogen atom, or a hydrocarbon group having 1 to 4 (preferably 1 to 2, and more preferably 1) carbon atoms. However, at least one of Z6 and Z7 is the structure represented by Structural Formula (Z101) above, the structure represented by Structural Formula (Z102) above, or the structure represented by Structural Formula (Z103) above.

Examples of an ion compound capable of forming the structure represented by Structural Formula (3) include the following cations having a pyridine ring structure and having a hydroxyl group:
1-hydroxymethylpyridinium cation, 1-(2-hydroxyethyl)pyridinium cation, 1-(3-hydroxypropyl)pyridinium cation, 1-(4-hydroxybutyl)pyridinium cation, 1-(6-hydroxyhexyl)pyridinium cation, 1-(8-hydroxyoctyl)pyridinium cation, 2-methyl-1-(2-hydroxyethyl)pyridinium cation, 3-methyl-1-(2-hydroxyethyl)pyridinium cation, 4-methyl-1-(2-hydroxyethyl)pyridinium cation, 3-ethyl-1-(2-hydroxyethyl)pyridinium cation, 3-n-butyl-1-(2-hydroxyethyl)pyridinium cation, 1-methyl-2-hydroxymethylpyridinium cation, 1-methyl-3-hydroxymethylpyridinium cation, 1-methyl-4-hydroxymethylpyridinium cation, 1-methyl-2-(2-hydroxyethyl)pyridinium cation, 1-methyl-3-(2-hydroxyethyl)pyridinium cation, 1-methyl-4-(2-hydroxyethyl)pyridinium cation, 1-ethyl-3-(2-hydroxyethyl)pyridinium cation, 1-n-butyl-3-(2-hydroxyethyl)pyridinium cation, 2-methyl-4-n-butyl-1-(2-hydroxyethyl)pyridinium cation;
1,2-bis(hydroxymethyl)pyridinium cation, 1,3-bis(hydroxymethyl)pyridinium cation, 1,4-bis(hydroxymethyl)pyridinium cation, 1,2-bis(2-hydroxyethyl)pyridinium cation, 1,3-bis(2-hydroxyethyl)pyridinium cation, 1,4-bis(2-hydroxyethyl)pyridinium cation, 1,2-bis(3-hydroxypropyl)pyridinium cation, 1,3-bis(3-hydroxypropyl)pyridinium cation, 1,4-bis(3-hydroxypropyl)pyridinium cation, 1,2-bis(4-hydroxybutyl)pyridinium cation, 1,3-bis(4-hydroxybutyl)pyridinium cation, 1,4-bis(4-hydroxybutyl)pyridinium cation, 1,2-bis(6-hydroxyhexyl)pyridinium cation, 1,3-bis(6-hydroxyhexyl)pyridinium cation, 1,4-bis(6-hydroxyhexyl)pyridinium cation, 1,2-bis(8-hydroxyoctyl)pyridinium cation, 1,3-bis(8-hydroxyoctyl)pyridinium cation, 1,4-bis(8-hydroxyoctyl)pyridinium cation, 2-methyl-1,3-bis(2-hydroxyethyl)pyridinium cation, 2-ethyl-1,3-bis(2-hydroxyethyl)pyridinium cation, 5-methyl-1,3-bis(2-hydroxyethyl)pyridinium cation, 5-ethyl-1,3-bis(2-hydroxyethyl)pyridinium cation;
1,2,4-(tris)hydroxymethylpyridinium cation, 1,2,4-tris(2-hydroxyethyl)pyridinium cation, 1,2,4-tris(3-hydroxypropyl)pyridinium cation, 1,2,4-tris(4-hydroxybutyl)pyridinium cation, 1,2,4-tris(6-hydroxyhexyl)pyridinium cation, 1,2,4-tris(8-hydroxyoctyl)pyridinium cation, 1,3,5-tris(hydroxymethyl)pyridinium cation, 1,3,5-tris(2-hydroxyethyl)pyridinium cation, 1,3,5-tris(3-hydroxypropyl)pyridinium cation, 1,3,5-tris(4-hydroxybutyl)pyridinium cation, 1,3,5-tris(6-hydroxyhexyl)pyridinium cation, and 1,3,5-tris(8-hydroxyoctyl)pyridinium cation; and derivatives thereof.

The cation having a pyridine ring structure and having at least one functional group including an amino group or a glycidyl group is not particularly limited. Examples thereof include cations having a structure in which a hydroxyl group of the cation having a pyridine ring structure exemplified above and a hydroxyl group is substituted with a functional group including an amino group or a glycidyl group.

The structure represented by Structural Formula (Z101) is a group formed through a reaction between the hydroxyl group that the cation has and an isocyanate group. The structure represented by Structural Formula (Z102) is a group formed through a reaction between the amino group that the cation has and an isocyanate group. The isocyanate group that reacts with the hydroxyl group or the amino group is preferably an isocyanate group that the raw material such as polyisocyanate in the polyurethane raw material mixture has. The structure represented by Structural Formula (Z103) is a group formed through a reaction between the glycidyl group that the cation has and a hydroxyl group. The hydroxyl group that reacts with the glycidyl group is preferably a hydroxyl group that the raw material such as polyisocyanate in the polyurethane raw material mixture has.

The polyurethane preferably has, among the structures represented by Structural Formulas (1) to (3), a structure represented by Structural Formula (1). Furthermore, the polyurethane preferably has, among structures represented by Structural Formula (1), a structure represented by Structural Formula (4). In a case where the polyurethane has a structure represented by Structural Formula (1), the dissociation rate between the anion and the cation in the polyurethane further increases due to a chemical structure of the cation. Therefore, it is possible to further increase the amounts of anion and cation that can move in the polyurethane, and an increase in electric resistance value is more easily curbed, which is favorable.

### Anion

The conductive elastic layer comprises an anion. It is possible to apply electrical conductivity to the conductive elastic layer by comprising the anion. The anion comprises at least one selected from the group consisting of (fluorosulfonyl)imide anion, (fluorosulfonate)imide anion, fluoroborate anion, fluorophosphate anion, dicyanamide anion, and thiocyanate anion.

The anion has a relatively large difference in solubility parameter from the polyurethane. Therefore, it is possible to restrict migration of the anion in the polyurethane and to curb an increase in electric resistance value at the time of a long-time operation by using the above-described anion.

Also, the above-described anion is chemically extremely stable as compared with halogen anion, sulfate anion, and nitrate anion due to its chemical structure, and the rate of dissociation from the cation is high. Specifically, since the anion has a strong electron-withdrawing group in the molecule to stabilize the negative charge of the anion, the anion exhibits high dissociation over a wide temperature range and can contribute to expression of high electrical conductivity in a wide temperature range. Therefore, it is considered to be possible to curb an increase in electric resistance value even at the time of a long-time operation in a low-temperature low-humidity environment by the conductive elastic layer comprising the above-described anion.

Specific examples of (fluorosulfonyl)imide anion include bis(fluorosulfonyl)imide anion. Specific examples of fluoroborate anion include tetrafluoroborate anion. Specific examples of fluorophosphate anion include hexafluorophosphate anion. Specific examples of (fluorosulfonate)imide anion include bis(fluorosulfonate)imide anion.

Among these anions, bis(fluorosulfonyl)imide anion is preferably included. The anion preferably includes at least bis(fluorosulfonyl)imide anion. In a case where bis(fluorosulfonyl)imide anion is used, the solubility parameter difference with the polyurethane having an ether bond can be easily controlled within an appropriate range. As a result, it becomes easier to restrict the migration of the anion and to curb an increase in electric resistance value, which is favorable.

The anion preferably comprises at least one selected from the group consisting of bis(fluorosulfonyl)imide anion, tetrafluoroborate anion, hexafluorophosphate anion, and bis(fluorosulfonate)imide anion. More preferably, the anion comprises at least one selected from the group consisting of bis(fluorosulfonyl)imide anion and bis(fluorosulfonate)imide anion.

### Polyurethane Raw Material Mixture

The conductive elastic layer of the conductive elastic roller comprises polyurethane comprising a urethane bond and an ether bond and an anion. Among these, thermosetting polyether polyurethane is preferably used because it also has flexibility.

Although a method of obtaining polyurethane having the cationic structures represented by Structural Formulas (1) to (3) is not particularly limited, it is possible to obtain the polyurethane by causing a compound having at least one functional group including a hydroxyl group, an amino group, or a glycidyl group to react with polyol and isocyanate, for example.

Polyol is not particularly limited, and it is possible to appropriately select and use one from among various polyols known as a raw material of polyurethane.

For example, it is possible to appropriately select and use one from among known polyols such as polyether polyol and polyester polyol generally used to manufacture soft polyurethane foam. One kind of polyol may be used, or two or more kinds of polyols may be used in combination.

Note that among the above-described polyols, polyether polyol is suitably used to manufacture soft highly elastic polyurethane foam with excellent humidity and heat durability. For example, polyethylene propylene ether triol, polyethylene propylene ester polyol, or the like is preferably used.

The number average molecular weight of the polyol is preferably 1000 to 10000, is more preferably 1500 to 8000, and is further preferably 2000 to 6000, for example. It is easy to control elasticity of the soft polyurethane foam to an appropriate range and to control elasticity of the foam roller to an appropriate range by the number average molecular weight of the polyol falling within the above-described range. Also, it is possible to use two or more kinds of polyols with different number average molecular weights in combination.

The polyisocyanate can be appropriately selected and used from among various polyisocyanates known as raw materials of the polyurethane.

Examples thereof include 2,4- and 2,6-tolylene diisocyanate (TDI), tolidine diisocyanate (TODI), naphthylene diisocyanate (NDI), xylylene diisocyanate (XDI), 4,4′-diphenylmethane diisocyanate (MDI), carbodiimide-modified MDI, polymethylene polyphenyl polyisocyanate, and polymeric polyisocyanate. The above polyisocyanate may be used alone, or two or more kinds thereof may be used in combination.

Note that an isocyanate group-terminated prepolymer obtained by causing polyisocyanate with one or two or more known active hydrogen compounds can also be used as the polyisocyanate.

The polyol and the polyisocyanate are preferably mixed such that the ratio (molar ratio) of an isocyanate group in the polyisocyanate to a hydroxyl group in the polyol is from 1.0 to 2.0. The mixture ratio within the above-mentioned range is preferable because it is easy to curb remaining of an unreacted component.

### Alkali Metal and Alkaline-Earth Metal

The sum of the content of alkali metal and alkaline-earth metal in the conductive elastic layer is 1.0×10⁻⁶ mol/g or less.

In the present disclosure, the alkali metal refers to, for example, lithium, sodium, potassium, rubidium, cesium, francium, or the like. Also, the alkaline-earth metal refers to, for example, magnesium, calcium, strontium, barium, radium, or the like.

The sum of the content of alkali metal and alkaline-earth metal in the conductive elastic layer is preferably 0.5×10⁻⁶ mol/g or less and is more preferably 0.3×10⁻⁶ mol/g or less. Although the lower limit is not particularly limited, the lower limit is, for example, 0.1×10⁻⁷ mol/g or more.

The sum of the content of alkali metal and alkaline-earth metal in the conductive elastic layer is preferably 0.1×10⁻⁷ to 1.0×10⁻⁶ mol/g, is preferably 0.1×10⁻⁷ to 0.5×10⁻⁶ mol/g, and is more preferably 0.1×10⁻⁷ to 0.3×10⁻⁶ mol/g.

As described above, alkali metal and alkaline-earth metal are likely to inhibit formation of a hydrogen bond between polymer chains of the polyurethane by coordinating with an ether bond that the polyurethane has.

The formation of a hydrogen bond between polymer chains of the polyurethane is not inhibited, and it is possible to restrict migration of the anion in the polyurethane, by the sum of the content of alkali metal and alkaline-earth metal in the conductive elastic layer being 0.5×10⁻⁶ mol/g or less. As a result, an increase in electric resistance value can be curbed even at the time of a long-time operation.

The content of alkali metal and alkaline-earth metal in the conductive elastic layer can be reduced by removing impurities in a process of producing the ion compound. The amount of anion in the conductive elastic layer increases in proportion to the amount of the ion compound blended in the above-described polyurethane raw material mixture. In other words, it is possible to control the content of alkali metal and alkaline-earth metal within the above-described range by removing the impurities while increasing the amount of blended ion compound with respect to the polyurethane raw material mixture.

Reasons that the alkali metal and the alkaline-earth metal are mixed into the conductive elastic layer include a case where such metal is originally comprised as impurities in the raw materials (for example, the ion compound, polyol, isocyanate, and the like) of the conductive elastic layer, a case where such metal is mixed thereinto in a manufacturing process of forming the conductive layer, and the like.

For example, a method in which metal comprised in the ion compound is removed is preferably used as a way of controlling the sum of the content of alkali metal and alkaline-earth metal in the conductive elastic layer within the above-described range. For example, it is possible to remove the metal in the ion compound by obtaining the ion compound by a neutralization reaction, which will be described later. As another way, the metal in the ion compound can be removed to some extent by causing the ion compound to pass through an ion exchange membrane a plurality of times.

The content of alkali metal and alkaline-earth metal in the ion compound is preferably 30000 ppm or less, is more preferably 15000 ppm or less, and is further preferably 10000 ppm or less.

Since the metal comprised in other materials is not comprised in the ion compound by obtaining the ion compound through a neutralization reaction, for example, it is possible to reduce the amount of alkali metal and alkaline-earth metal comprised as impurities. On the other hand, in the case where the ion compound is obtained by the neutralization reaction, the yield is likely to become low for the reason described later.

According to the investigation made by the present inventors, it has been found to be possible to obtain an ion compound with low content of alkali metal and alkaline-earth metal at a high yield by causing a neutralization reaction between a compound having a precursor of the above-described cation having a hydroxyalkyl group and a hydroxide ion and a compound having an anion and a hydrogen ion at a low concentration for a long period of time.

A solution comprising the precursor of the cationic structure having a hydroxyalkyl group and a hydroxide ion are strongly basic. In the strongly basic solution, desorption of the hydroxyalkyl group bonded to a nitrogen atom in the structure of the above-described cationic structure precursor and dehydration-condensation with another hydroxyalkyl group are likely to occur, resulting in a low yield. It is known that in a case of a structure in which a hydrogen atom is bonded to the second position of a nitrogen-containing heterocycle in the above-described precursor of the cation, in particular, a part of the strongly basic system may have an N-heterocyclic carbene structure, and the carbene structure does not contribute to the neutralization reaction for obtaining the target object, and the yield is thus likely to become low as a result.

Therefore, it is considered to be difficult in some cases to employ the neutralization reaction as a synthesis method for obtaining a salt of the precursor of the above-described cation having a hydroxyalkyl group from the viewpoint of the yield.

On the other hand, the present inventors have found that the salt of the precursor of the above-described cation having a hydroxyalkyl group can be obtained at a high yield by performing the neutralization reaction at a low concentration for a long period of time.

### Method for Producing Ion Compound

A method for producing the ion compound comprises, for example, the following processes.
Process (1): a process of obtaining a cation salt intermediate 1, which is a cation in ion compounds represented by Formulas (A) to (C) below
Process (2): a process of obtaining a cation salt intermediate 2 having a hydroxide anion by adding an ion exchange resin to the cation salt intermediate 1 and performing ion exchange
Process (3): a process of causing a neutralization reaction between the cation salt intermediate 2 and a compound having a desired anion and a hydrogen ion

A method for obtaining the cation salt intermediate 1 in above-described Process (1) is not particularly limited, and it is possible to use a known method.

In above-described Process (2), the cation salt intermediate 1 is dissolved in water or the like, and an ion exchange reaction is performed by adding an ion exchange resin, thereby obtaining the cation salt intermediate 2 having a hydroxide anion. As the ion exchange resin, a known anion exchange resin can be used. After the reaction, the ion exchange resin is filtered, thereby obtaining an aqueous solution of the cation salt intermediate 2.

In the above-described process (3), a cation salt intermediate 2 and the compound having a desired anion and a hydrogen ion are subjected to a neutralization reaction. For example, it is preferable to add an aqueous solution of the anion dropwise to an aqueous solution of the cation salt intermediate 2. As the desired anions, it is possible to use at least one selected from the group consisting of (fluorosulfonyl)imide anion, (fluorosulfonate)imide anions, fluoroborate anion, fluorophosphate anion, dicyanamide anion, and a thiocyanate anion.

For example, it is preferable to add an aqueous solution of above-described anion dropwise to the aqueous solution of the cation salt intermediate 2. At this time, the concentration of the aqueous solution of the cation salt intermediate 2 is preferably 0.1 to 10% by mass. The concentration of the aqueous solution of anion is preferably 1 to 30% by mass. It is also preferable to perform the neutralization reaction for 30 minutes to 10 hours.

In order to cause the sum of the content of alkali metal and alkali-earth metal in the conductive elastic layer to fall within the above-described range, the following liquid composition preferably comprises an ion compound.

The liquid composition preferably comprises at least one selected from the group consisting of an ion compound represented by the Structural Formula (6) below and an ion compound represented by Structural Formula (7) below. It is more preferable that the liquid composition comprise the ion compound represented by Structural Formula (7) below.

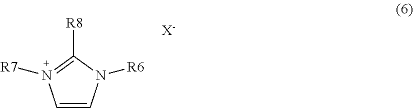

In Structural Formula (6), R6 to R8 each independently represent an alkyl group having 1 to 4 carbon atoms, a hydroxyalkyl group having 1 to 4 carbon atoms, or a hydrogen atom. At least one of R6 to R8 is a hydroxyalkyl group having 1 to 4 carbon atoms. X⁻ represents an anion.

It is preferable that at least one of R6 to R8 be a hydroxyalkyl group having 1 to 2 carbon atoms while the remaining two are alkyl groups having 1 to 2 carbon atoms. It is preferable that R6 be a hydroxyalkyl group having 1 to 2 carbon atoms while R7 and R8 are alkyl groups having 1 to 2 carbon atoms. X⁻ is preferably bis(fluorosulfonyl)imide anion.

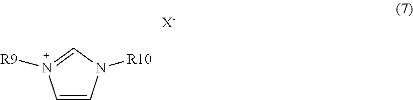

In Structural Formula (7), R9 and R10 each independently represent an alkyl group having 1 to 4 carbon atoms, a hydroxyalkyl group having 1 to 4 carbon atoms, or a hydrogen atom. At least one of R9 and R10 is a hydroxyalkyl group having 1 to 4 carbon atoms. X⁻ represents an anion.

It is preferable that at least one of R9 and R10 be a hydroxyalkyl group having 1 to 2 carbon atoms. It is preferable that R9 and R10 be hydroxyalkyl groups having 1 to 2 carbon atoms. X⁻ is preferably bis(fluorosulfonyl)imide anion.

The content of the above ion compound in the liquid composition is preferably 95 to 100% by mass. The content of the above ion compound in the liquid composition is more preferably 97 to 100% by mass, and is further preferably 98 to 100% by mass.

The sum of the content of alkali metal and alkaline-earth metal in the liquid composition is preferably 30000 ppm or less.

The sum of the content of alkali metal and alkaline-earth metal in the liquid composition is preferably 15000 ppm or less, and is more preferably 10000 ppm or less. Although the lower limit is not particularly limited, the lower limit is, for example, 100 ppm or more. The sum of the content of alkali metal and alkaline-earth metal in the liquid composition is preferably 100 to 30000 ppm, is more preferably 100 to 15000 ppm, and is even more preferably 100 to 10000 ppm.

The viscosity of the liquid composition at 23 °C is preferably 1 to 1000 mPa·s. The viscosity of the liquid composition of less than 1 mPa·s at 23 °C is likely to lead to an increase in mixture time needed to enhance dispersibility of the liquid composition in an elastic layer forming material, which will be described later. If the viscosity is greater than 1000 mPa·s, it may be difficult to uniformly disperse the liquid composition in the elastic layer forming material, which will be described below.

It becomes easier to uniformly control the dispersibility of the liquid composition in the elastic layer forming material, which will be described later, and to further express the effect of the present disclosure, by the viscosity of the liquid composition at 23 °C falling within the above range.

The viscosity of the liquid composition at 23 °C can be controlled by, for example, the type and the blending amount of the ion compound. It becomes easier to control the viscosity within the above-described range by setting the content of the ion compound in the liquid composition within the above-described range, for example.

The viscosity of the liquid composition at 23 °C is preferably 1 to 100 mPa·s, is more preferably 3 to 50 mPa·s, and is further preferably 5 to 20 mPa·s.

It becomes easier to control the sum of the content of alkali metal and the content of alkaline-earth metal in the conductive elastic layer to be 1.0×10⁻⁶ mol/g or less and to further restrict migration of the anion in the polyurethane by forming the conductive elastic layer using the above-described liquid composition as an ion compound. In this manner, it becomes easier to suitably manufacture the conductive elastic roller capable of curbing an increase in electric resistance value even at the time of long-time operation.

The difference between the solubility parameter of the polyurethane and the solubility parameter of the anion is preferably 0.60 to 2.00 ((J/cm)³)^{0.5}

The difference between the solubility parameters become sufficiently large, and it thus becomes easier to restrict the migration of the anion in the polyurethane, by the difference in solubility parameters between the polyurethane and the anion satisfying the condition of 0.60 ((J/cm)³)^{0.5} or more. It becomes easy for the anion in the polyurethane to moderately move by the difference between the solubility parameters satisfying the condition of 2.00 ((J/cm)³)^{0.5} or less. It becomes easy to control the electric resistance value to be lower while maintaining the electrical conductivity of the conductive elastic roller by setting the difference in solubility parameters between the polyurethane and the anion within the above-described range.

Although the solubility parameter of the polyurethane is not particularly limited, the solubility parameter is preferably 3.00 to 15.00 ((J/cm)³)^{0.5}, is more preferably 5.00 to 10.00 ((J/cm)³)^{0.5}, and is further preferably 7.00 to 9.00 ((J/cm)³)^{0.5}

Although the solubility parameter of the anion is not particularly limited, the solubility parameter is preferably 5.00 to 15.00 ((J/cm)³)^{0.5}, is more preferably 7.00 to 13.00 ((J/cm)³)^{0.5}, and is further preferably 9.00 to 10.00 ((J/cm)³)^{0.5}

Note that a method of measuring the solubility parameters will be described later.

When the conductive elastic layer of a conductive elastic roller is measured by a differential scanning calorimeter (DSC), it is preferable that one or more endothermic peaks be present in the range of 40 °C to 70 °C on a specific heat curve when the temperature is raised from 30 °C to 200 °C at a temperature raising speed of 10 °C/min.

The present inventors consider that how high the stability of the conductive elastic layer is can be confirmed on the basis of thermal responsiveness, by having one or more endothermic peaks in a high temperature range in the DSC measurement of the conductive elastic layer.

In a case where the conductive elastic layer comprises the above-described anion and the polyurethane having the above-described cationic structure, a structure like pseudo-crosslinking is formed in the polyurethane due to electrical interaction between the anion and the cation. The presence of such a pseudo-crosslinking structure can be detected as an endothermic peak through the DSC measurement of the conductive elastic layer.

Having one or more endothermic peaks in a high temperature range of 40 °C to 70 °C is considered to indicate that pseudo-crosslinking has strongly been formed in the polyurethane. Therefore, it becomes easier to restrict the migration of the anion and to further curb an increase in electric resistance value.

The conductive elastic layer has the one or more endothermic peaks more preferably in a temperature range of 50 °C to 70 °C, and yet more preferably in a temperature range of 60 °C to 70 °C. Examples of a way to raise the endothermic peak temperature include reducing the content of alkali metal and alkaline-earth metal in the conductive elastic layer, selecting a material to narrow the distance between crosslinking points of the polyurethane, and the like. For example, it is possible to raise the endothermic peak temperature by selecting a low-molecular-weight material among materials for forming polyurethane.

As described above, the conductive elastic roller comprising the conductive elastic layer can be suitably used as a toner supply roller, in particular. The toner supply roller is required to have performance of uniformly supplying a toner to a developing roller surface, and properties such as an average cell diameter, the number of cells, and the air flow rate on the surface, the density of the entire foam conductive elastic layer, and the like are important.

The conductive elastic roller is preferably a foam conductive elastic roller. In other words, the conductive elastic layer is preferably a foam conductive elastic layer.

The foam conductive elastic layer has a large number of significantly minute structures in the layer. The minute structures have an effect of hindering the migration of the anion. Therefore, since the conductive elastic layer is the foam conductive elastic layer, migration of the anion can also be restricted by the structure of the conductive elastic layer, it is possible to maintain the property of the low electric resistance value for a yet longer period of time.

Although physical property values of the foam conductive elastic layer are not particularly limited, it is preferable to have values within the following numerical ranges, for example.

The surface average cell diameter of the foam conductive elastic layer is preferably 80 to 500 μm. It is possible to more suitably restrict the migration of the anion by the surface average cell diameter of the foam conductive elastic layer falling within the above-described range, and it is thus possible to further maintain the property of the low electric resistance value for a yet longer period of time.

The surface average cell diameter of the foam conductive elastic layer is more preferably 100 to 500 μm, and is further preferably 200 to 400 μm.

The surface average cell diameter can be controlled by production conditions of the conductive elastic layers and addition of an aid, which will be described later, for example. It is possible to control the surface average cell diameter within the above-described range by the types and the amounts of a blowing agent, a foam stabilizer, and the like, which will be described later, for example.

The number of cells on the surface of the foam conductive elastic layer is preferably from 50 to 300 cells/inch. The air flow rate of the surface of the foam conductive elastic layer is preferably from 0.5 to 3.0 L/min. The density of the surface of the foam conductive elastic layer is preferably from 0.05 to 0.20 g/cm³, for example.

### Others

In the conductive elastic layer of the conductive elastic roller, it is possible to use a catalyst, a blowing agent, a foam stabilizer, and other auxiliary agents as necessary.

The catalyst is not particularly limited, and a catalyst can be appropriately selected and used from various kinds of conventionally known catalysts. For example, amine-based catalysts (triethylenediamine, bis(dimethylaminoethyl) ether, N,N,N′,N′-tetramethylhexanediamine, 1,8-diazabicyclo(5,4,0)undecene-7, 1,5-diazabicyclo(4,3,0)nonene-5, 1,2-dimethylimidazole, N-ethylmorpholine, N-methylmorpholine, and the like), organometallic catalysts (tin octylate, tin oleate, dibutyltin dilaurate, dibutyltin diacetate, tetra-i-propoxytitanium, tetra-n-butoxytitanium, tetrakis(2-ethylhexyloxy)titanium, and the like), and acid salt catalysts obtained by lowering the initial activities of the amine-based catalysts and the organometallic catalysts (carboxylates, formates, octylates, borates, and the like) can be used. One kind of the catalyst may be used, or two or more kinds thereof may be used in combination.

The blowing agent is not particularly limited, and a blowing agent can be appropriately selected from various kinds of known blowing agents and used. In particular, water reacts with the polyisocyanate to generate carbon dioxide gas and is thus suitably used as the blowing agent. In addition, other blowing agents may also be jointly used with water.

The foam stabilizer is not particularly limited, and a foam stabilizer can be appropriately selected from various kinds of known foam stabilizers and used. It is possible to use, for example, a silicone foam stabilizer.

As the other auxiliary agents, a crosslinking agent, a flame retardant, a coloring agent, an ultraviolet absorbent, an antioxidant, a conductive filler, or the like may be used as necessary to an extent that the effect of the present disclosure is not hindered. As the conductive filler, it is possible to use carbon black; and conductive metal such as aluminum and copper. Furthermore, other ion compounds may also be jointly used to an extent that the effect of the present disclosure is not impaired.

When the conductive elastic layer is formed, the content of ion compound in the raw material mixture is preferably 0.1 to 30 parts by mass with respect to 100 parts by mass of binder resin forming the conductive elastic layer from the viewpoint of stability. In a case where a plurality of ion compounds are used together, the sum of the content thereof preferably falls within the above-described range.

### Method of Forming Foam Conductive Elastic Layer

A formation method in a case where the conductive elastic layer is formed as a foam conductive elastic layer is not particularly limited, and a known method can be used. It is possible to use any method such as a method using a blowing agent or a method of mixing air bubbles through mechanical stirring. The foaming ratio may be determined as appropriate and is not particularly limited.

For example, the foam conductive elastic layer of the foam conductive elastic roller is obtained by causing a reaction of an elastic layer forming material obtained by mixing the following materials while foaming the material.
1. Materials for forming a binder resin
   Polyol (such as polyether polyol)
   Polyisocyanate
2. A compound that has at least one functional group including a hydroxyl group, an amino group, or a glycidyl group in a cationic structure
3. Catalyst
4. Foam stabilizer
5. Blowing agent

The elastic layer forming material comprises a compound comprising a nitrogen-containing heteroaromatic ring structure, and a polyurethane raw material mixture that forms polyurethane. As the compound comprising a nitrogen-containing heteroaromatic ring structure, it is possible to use the ion compound or the liquid composition comprising the ion compound described above. The polyurethane raw material mixture comprises, for example, polyol and polyisocyanate.

The elastic layer forming material preferably comprises at least a liquid composition comprising an ion compound, polyol, and polyisocyanate. In the case where the elastic layer is formed as a foam, a blowing agent may further be comprised.

The ion compound is preferably any of ion compounds represented by Formulas (A) to (C) below. The ion compound is preferably obtained by the above-described neutralization reaction. The ion compound is more preferably the ion compound represented by Structural Formula (6) above.

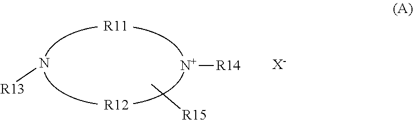

In Formula (A), R11 and R12 represent a hydrocarbon group needed to form a nitrogen-containing heteroaromatic 5-membered ring together with a nitrogen atom to which each of R11 and R12 is bonded. R13 to R15 represent a functional group including a hydroxyl group, an amino group, or a glycidyl group, a hydrogen atom, or a hydrocarbon group having 1 to 4 carbon atoms, and at least one of R13 and R15 represents a functional group including a hydroxyl group, an amino group, or a glycidyl group. At least one of R13 to R15 is preferably a hydroxyalkyl group having 1 to 4 carbon atoms. X⁻ represents an anion.

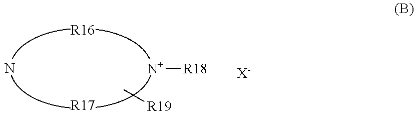

In Formula (B), R16 and R17 represent a hydrocarbon group needed to form a nitrogen-containing heteroaromatic 6-membered ring together with a nitrogen atom to which each of R16 and R17 is bonded. R18 and R19 represent a functional group including a hydroxyl group, an amino group, or a glycidyl group, a hydrogen atom, or a hydrocarbon group having 1 to 4 carbon atoms, and at least one of R18 and R19 represents a functional group including a hydroxyl group, an amino group, or a glycidyl group. At least one of R18 and R19 is preferably a hydroxyalkyl group having 1 to 4 carbon atoms. X⁻ represents an anion.

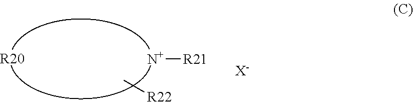

In Formula (C), R20 represents a hydrocarbon group needed to form a nitrogen-containing heteroaromatic ring together with a nitrogen atom to which R20 is bonded. R21 and R22 represent a functional group including a hydroxyl group, an amino group, or a glycidyl group, a hydrogen atom, or a hydrocarbon group having 1 to 4 carbon atoms, and at least one of R21 and R22 represents a functional group including a hydroxyl group, an amino group, or a glycidyl group. At least one of R21 and R22 is preferably a hydroxyalkyl group having 1 to 4 carbon atoms. X⁻ represents an anion.

Note that the sum of the content of ion compound in the elastic layer forming material is preferably within the following range from the viewpoint of electrical conductivity and curbing of variation in resistance due to electrification. In other words, the content of ion compound in the elastic layer forming material is preferably 0.1 to 30 parts by mass, is more preferably 1.0 to 10.0 parts by mass, and is further preferably 3.0 to 5.0 parts by mass with respect to 100 parts by mass of binder resin.

Although the content of polyol in the elastic layer forming material is not particularly limited, the content of polyol is preferably 50.0 to 90.0 parts by mass, is more preferably 60.0 to 85.0 parts by mass, and is further preferably 70.0 to 80.0 parts by mass, for example.

Although the content of polyisocyanate in the elastic layer forming material is not particularly limited, the content of polyisocyanate is preferably 5.0 to 30.0 parts by mass, is more preferably 7.0 to 25.0 parts by mass, and is further preferably 10.0 to 20.0 parts by mass, for example.

Although the content of blowing agent in the elastic layer forming material is not particularly limited, the content of blowing agent is preferably 0.3 to 3.0 parts by mass, is more preferably 0.5 to 2.5 parts by mass, and is further preferably 0.7 to 2.0 parts by mass, for example.

It is possible to form the conductive elastic layer by mixing the elastic layer forming material and causing a reaction. The mixing temperature and time are not particularly limited. The mixing temperature is normally from 10 to 90 °C and preferably within a range from 20 to 70 °C. In addition, the mixing time is normally from one second to 15 minutes and preferably from three seconds to 10 minutes while depending on the structure of a mixing unit to be used, the rotation conditions, or the like.

A method for joining the substrate and the conductive elastic layer is not particularly limited. It is possible to use a method in which the substrate is disposed in a mold (mold die) in advance and the raw material mixture as described above is cast and cured, a method in which the raw material mixture is shaped into a predetermined shape, which is to be a conductive elastic layer, in advance and is then made to adhere to the substrate, or the like. In any method, it is possible to provide an adhesive layer between the substrate and the conductive elastic layer as needed. As this adhesive layer, a known material such as an adhesive or a hot melt sheet can be used.

In the case of casting and curing the raw material mixture, a mold release agent may be applied to the inner wall of the mold in advance. As the mold release agent, known mold release agents can be used. Examples thereof include aqueous mold release agents comprising a wax component and a silicone oil and mold release agents obtained by dissolving a fluorine resin in a fluorine-based solvent. Examples of a fluororesin-containing mold release agent include fluororesin-containing mold release agents (trade name: FLUORO SURF, FG-5093F130-0.5, manufactured by Fluoro Technology Co., Ltd.).

A method for forming the shape of the conductive elastic layer as the conductive elastic roller is not particularly limited. For example, in addition to a method in which the raw material mixture is cast in the mold having a predetermined shape described above or the like, the following methods or the like can be used. Examples of the method include a method in which polyurethane foam in a block state is cut into a predetermined dimension by cutting, a method in which polishing is performed to obtain a predetermined dimension, and a method achieved by appropriately combining these methods.

A method of manufacturing the conductive elastic roller preferably includes, for example, a process of pouring the elastic layer forming material to a mold with a substrate disposed therein and a process of heating the mold and curing the elastic layer forming material, thereby forming the conductive elastic layer.

The conductive elastic roller may comprise a conductive elastic layer which is not a foam.

The conductive elastic roller preferably comprises a conductive substrate, an elastic layer on the substrate, and a surface layer on the elastic layer. The surface layer preferably comprises the above-described polyurethane and the above-described anion. In a case where the surface layer is formed, the elastic layer and the surface layer function as the conductive elastic layer.

An example of a method of manufacturing a conductive elastic roller in which the elastic layer is not foamed will be described below.

The method of manufacturing such a conductive elastic roller includes, for example, a process of forming an elastic layer on an outer peripheral surface of a substrate and a process of forming a surface layer on an outer surface of the elastic layer to thereby obtain a conductive elastic roller.

The above-described substrate can be used as the substrate. The elastic layer is preferably a silicone rubber elastic layer, for example.

As a material for forming the silicone rubber elastic layer, a silicone rubber composition comprising a liquid silicone rubber material, and if needed, additives such as a heat resistance improver and a catalyst can be used.

For example, the silicon rubber composition is poured as a material of the elastic layer into the mold with the substrate disposed therein, and the silicone rubber is cured. It is possible to form the silicone rubber elastic layer on the outer surface of the substrate by heating it at a temperature of 100 °C to 200 °C for 5 to 20 minutes, for example.

The surface layer is formed on the outer surface of the thus formed elastic layer. As a material for forming the surface layer, it is possible to use a surface layer forming coating comprising a compound comprising a nitrogen-containing heteroaromatic ring structure and a polyurethane raw material mixture which forms a polyurethane. As the compound comprising a nitrogen-containing heteroaromatic ring structure, the above-described liquid composition can be used. The polyurethane raw material mixture comprises, for example, polyol and polyisocyanate.

The surface layer forming coating is applied to the surface of the formed elastic layer. For example, after the elastic layer is formed, a coating film is formed on the surface of the elastic layer by forming the elastic layer and immersing it in the surface layer forming coating prepared in advance. After that, the coating film is dried and is then subjected to heat treatment, thereby forming the surface layer comprising polyurethane. The heating is preferably performed at 100 °C to 200 °C for 30 minutes to 3 hours, for example.

It is possible to obtain a conductive elastic roller comprising the substrate, the elastic layer on the substrate, and the surface layer on the elastic layer through the above processes.

### Electrophotographic Image Forming Apparatus

An electrophotographic image forming apparatus according to another aspect of the present disclosure comprises the above-described conductive elastic roller. In other words, the conductive elastic roller according to an aspect of the present disclosure can be used as a developing roller, a charging roller, and a toner supply roller in the electrophotographic image forming apparatus. In a case where the conductive elastic roller is a foam conductive elastic roller, the conductive elastic roller is suitably used as a toner supply roller, in particular.

The foam conductive elastic roller can also be applied to any developing device out of a non-contact type developing device or a contact type developing device using a magnetic single-component toner or a non-magnetic single-component toner.

The electrophotographic image forming apparatus comprises at least an electrophotographic photosensitive member, a developing roller disposed in contact with the electrophotographic photosensitive member, and a developer supplying roller for supplying a developer to the developing roller. It is preferable that the developer supply roller be the above-described foam conductive elastic roller.

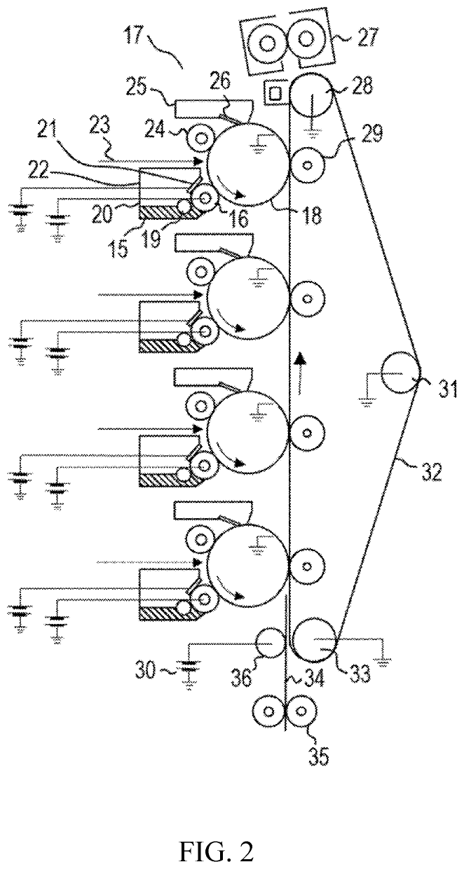

FIG. 2 is a schematic sectional view illustrating an example of the electrophotographic image forming apparatus in which a foam conductive elastic roller is mounted as a toner (developer) supply roller of a contact-type developing device using a single-component toner.

A developing device 22 comprises a toner container 20 storing a toner 15 as the single-component toner, a developing roller 16, a toner supply roller 19 that supplies a toner to the developing roller 16, and a developing blade 21 that regulates the thickness of a toner layer on the developing roller 16. The developing roller 16 is located at an opening extending in the longitudinal direction inside the toner container 20 and is installed in contact with an electrophotographic photosensitive member 18.

Note that the electrophotographic photosensitive member 18, a cleaning blade 26, a waste toner storage container 25, and a charging roller 24 may be disposed in the main body of the electrophotographic image forming apparatus. The developing device 22 is prepared for each of color toners of Black (Bk), cyan (C), magenta (M), and yellow (Y) and can perform color printing.

Hereinafter, a print operation of the electrophotographic image forming apparatus will be described.

The electrophotographic photosensitive member 18 rotates in the arrow direction and is uniformly charged by the charging roller 24 for charging the electrophotographic photosensitive member 18. Next, an electrostatic latent image is formed on the surface of the electrophotographic photosensitive member 18 with laser light 23, which is an exposure means. The electrostatic latent image is visualized (developed) as a toner image with the toner 15 applied from the developing roller 16 disposed in contact with the electrophotographic photosensitive member 18 by the developing device 22. The development is a so-called reversal development in which a toner image is formed on an exposure part.

The toner image formed on the electrophotographic photosensitive member 18 is transferred to paper 34, which is a recording medium, with transfer rollers 29, which are transfer members. The paper 34 is fed into the apparatus via a paper feed roller 35 and an adsorption roller 36, and is conveyed between the electrophotographic photosensitive member 18 and the transfer rollers 29 with an endless belt-like transfer conveyor belt 32. The transfer conveyor belt 32 is operated by a driven roller 33, a driving roller 28, and a tension roller 31. A voltage is applied from a bias power source 30 to the developing roller 16, the developing blade 21, the toner supply roller 19, and the adsorption roller 36.

The paper 34 to which the toner image has been transferred is subjected to a fixing treatment with a fixing apparatus 27 and then ejected to the outside of the apparatus, and the printing operation is finished. Meanwhile, transfer residual toner remaining on the electrophotographic photosensitive member 18 without being transferred is scraped off with the cleaning blade 26, which is a cleaning member for cleaning the surface of the photosensitive member, and stored in the waste toner storage container 25. The cleaned electrophotographic photosensitive member 18 repeats the above-described printing operation.

### Process Cartridge

A process cartridge according to another aspect of the present disclosure comprises above-described conductive elastic roller. In particular, the conductive elastic roller can be suitably used as the toner supply roller 19 in the process cartridge.

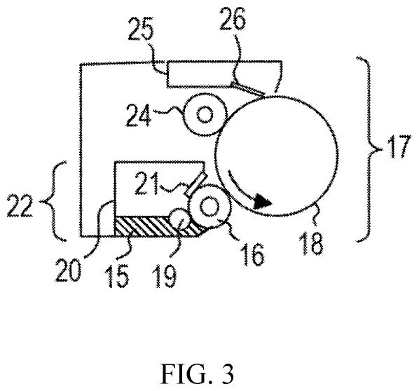

FIG. 3 is a schematic cross-sectional view illustrating one example of the process cartridge. A process cartridge 17 is configured to be attachable to and detachable from the main body of the electrophotographic image forming apparatus. In addition, the developing device 22, the electrophotographic photosensitive member 18, the cleaning blade 26, which is a cleaning means, the waste toner storage container 25, and the charging roller 24, which is a charging means, are integrated in the process cartridge 17.

Here, the developing device 22 comprises the developing roller 16, which is a developing means, and the developing blade 21. The developing device 22 further comprises the toner container 20, and the toner container 20 is filled with the toner 15. The toner 15 in the toner container 20 is supplied to the surface of the developing roller 16 by the toner supply roller 19, and a layer of the toner 15 having a predetermined thickness is formed on the surface of the developing roller 16 by the developing blade 21.

### Concerning Method of Supplying Toner by Toner Supply Roller

Examples of a method of supplying the toner to the developing roller 16 by the toner supply roller 19 include a mechanical supply method and an electrical supply method.

The mechanical supply method is a method in which the toner is held on the surface layer of the toner supply roller 19 and the toner is supplied through contact with the developing roller 16. At this time, if the surface layer of the toner supply roller 19 is a layer having voids such as a foam layer, the amount of the toner held increases, and it is possible to more efficiently supply the toner. Furthermore, if the surface layer of the toner supply roller 19 is a conductive elastic layer, the held toner is pushed out by the conductive elastic layer contracting at the time of contact with the developing roller 16, and discharge of the toner from the toner supply roller 19 is prompted.

The electrical supply method uses a biasing force of a charged toner due to a bias potential difference between the bias applied to the toner supply roller 19 and the bias applied to the developing roller 16. Specifically, in a case where the polarity of the bias potential difference is the same polarity as the normal charging polarity of the toner, a biasing force on the developing roller 16 side from the toner supply roller 19 works on the toner at the contact portion. The toner is supplied in this manner.

The process cartridge preferably has a contact member which is electrically connected to an electric contact of the main body when the process cartridge is mounted on the main body of the electrophotographic image forming apparatus. The process cartridge comprises a developing roller, and a developer supply roller for supplying a developer to the developing roller, and is preferably configured to apply a voltage between the developing roller and the developer supply roller through electrical connection to the main body. The developer supply roller is preferably the above-described conductive elastic roller.

A method of measuring physical properties of the conductive elastic roller will be described.

### Measurement of Solubility Parameters (SP Values)

The solubility parameters (SP values) of the polyurethane and the anion are measured as follows.

### Preparation of Sample

In a case where raw materials for the polyurethane to be used for the conductive elastic roller are available, a sample obtained by synthesizing only the polyurethane is used to perform measurement. Alternatively, it is also possible to use a sample obtained by getting and synthesizing the raw materials on the basis of information obtained by structure analysis of the polyurethane of the conductive elastic roller.

In a case where the anion is measured, it is possible to extract an anion component from the conductive elastic roller and to use it as a sample. For example, 2 g of the conductive elastic layer is immersed in 10 ml of acetone to extract the anion. A solution obtained by evaporating acetone to dryness thereafter and dissolving it in 10 ml of acetonitrile can be used as a sample.

Furthermore, it is also possible to specify an anion component by analysis and to use a similar anion obtained separately as a sample.

### Measurement of SP Values

0.5 g of the above-described sample is weighed into a 100 ml beaker, and 10 ml of good solvent is added thereto using a hole pipette, and the mixture is sufficiently stirred and dissolved. Next, a poor solvent is added dropwise using a 50 ml burette, and the drop amount at the point of occurrence of cloudiness is measured.

In the present disclosure, acetone is used as a good solvent, and n-hexane is used as a poor solvent, in the case where polyurethane is measured. In the case where the anion is measured, 1,4-dioxane is used as a good solvent, and ion-exchanged water is used as a poor solvent.

The SP value 6 is calculated as follows. The measurement is performed three times, and an arithmetic mean value is defined as the SP value.

δ={(Vml)^{1/2}δ·ml+((Vmh)^{1/2}·δmh)}/{(Vml)^{1/2}+(Vmh)^{1/2}}
Vi: Molar volume of solvent (ml/mol)
φ i: The volume fraction of each solvent at the point of occurrence of cloudiness.
δi: The SP value of each solvent
ml: Low SP poor solvent mixed system
mh: High SP poor solvent mixed system

The molar volumes and the SP values of solvents 1 and 2 (the good solvent and the poor solvent) can be obtained using the following formulas.

Vm=V1V2/(φ1V2+φ2V1)

δm=φ1δ1+φ2δ2
Reference: “J.P.S. A-1, 5, 1671 to 1681 (1967), SUH CLARKE”

### Method of Evaluating Content and Viscosity of Liquid Composition

The content of ion compound in the liquid composition can be measured by the solid content ratio measurement based on the thermal weight loss method, proton nuclear magnetic resonance (¹H-NMR), liquid chromatography mass spectrometry (LC/MS), or the like. The measurement may be made by one of these methods or a combination of a plurality of these methods. Specifically, it is possible to perform the measurement by the following method, for example.

10 mg of liquid composition is dissolved in 2 mL of acetonitrile to prepare a 5000 g/mL solution. 960 μL of acetonitrile is added (25 times dilution) to 40 μL of this adjusted solution to prepare 1.0 mL of a 200 g/mL solution, and the mixture is filtered with a 0.2 m filter to thereby obtain a measurement sample.

As measurement conditions, the following apparatus and conditions are used.

### Apparatus

Ultimate 3000/LCQ FLEET (manufactured by Thermo)
   (HPLC conditions)
Column: Acclaim Trinity P1 3 μm 2.1×100 mm (manufactured by Thermo)

### (Mixed Mode of a Reversed Phase (RP), Strong Cation Exchange (SCX), and Weak Anion Exchange (WAX))

Column temperature: 30 °C
Mobile phase: A: acetonitrile B: 100 mM aqueous solution of ammonium formate (pH 5.0) C: pure water

### A/B/C=70/1/29 (Isocratic)

Flow rate: 0.5 mL/min
Detector: Corona Veo (Corona CAD), PDA (190 nm to 800 nm)
Injection amount: 10 μL
Analysis time: 10 minutes

### Mass Spectrometry

Ionization: ESI positive/negative
Scan ranges: M/z 50 to 2000

### Creation of Calibration Curve

A calibration curve is created from results of performing measurement under the above-described analysis conditions using calibration curve creation samples prepared by pre-mixing an ion compound into 1 g of ion exchange water at mass concentrations of 25% by mass, 50% by mass, and 75% by mass, and an ion compound before mixing with the ion exchange water.

### Analysis

The peak area at the masses corresponding to the ion compounds are calculated. The results of the measurement sample and the calibration curve are used to obtain the content of the ion compound in the liquid composition.

The content of alkali metal and alkaline-earth metal in the liquid composition can be measured by inductively coupled high-frequency plasma emission spectrometry (ICP-AES), inductively coupled plasma mass spectrometry (ICP-MS), or the like. Specifically, it is possible to perform the measurement by the following method, for example.

10 mg of the liquid composition is weighed, 5 mL of ultrapure water is added thereto, and the mixture is filtered with a 0.45 m membrane filter to thereby obtain a measurement sample.

### Analysis Conditions

Apparatus: Integrion RFIC (manufactured by Thermo)
Standard solution: Cation mixed standard solution-II (manufactured by Kanto Chemical Co., Inc.)
Column: CS-16 (manufactured by Thermo)
Column temperature: /40 °C
Mobile phase: 30 mM aqueous solution of methanesulfonic acid (cation)
Flow rate: 0.36 mL/min (cation)
Detector: Electrical conductivity
Injection amount: 10 μL
Analysis time: 27 minutes (cation)

### Creation of Calibration Curve

The above-described standard solution is mixed with ion exchange water, and samples at concentrations of 10% by mass and 50% by mass and samples before being mixed with the ion exchange water are used as calibration curve creation samples. Analysis is performed using these samples to create a calibration curve.

### Analysis

The peak area of the measurement sample is calculated for each cation. The results of the measurement sample and the calibration curve are used to obtain the content of alkali metal and alkaline-earth metal in the liquid composition.

Furthermore, the viscosity of the liquid composition at 23 °C can be measured by a B-type viscometer, an E-type viscometer, a rheometer, or the like. Specifically, it is possible to perform the measurement by the following method, for example.

An E-type viscometer (RE500L manufactured by Toki Sangyo Co., Ltd.) is used, and a 0.8°×R24 cone rotor is used. As measurement conditions, the measurement is carried out at a measurement temperature of 23 °C and with the sample amount of 0.6 ml to measure the viscosity of the liquid composition.

### Method of Evaluating Sum of Content of Alkali Metal and Alkaline-Earth Metal in Conductive Elastic Layer

The sum of the content of alkali metal and alkali-earth metal in the conductive elastic layer is measured as follows.

0.5 g of conductive elastic layer is immersed in 5 ml of acetone to extract alkali metal and alkaline-earth metal, and then the acetone is evaporated to dryness. The extract dissolved in 5 ml of ultrapure water is used as a sample.

It is also possible to use an ion compound or a liquid composition comprising an ion compound as a sample. In a case where an ion compound is used as a sample, it is possible to obtain the sample similarly to the above-described method other than that 0.01 g of ion compound is immersed in 10 ml of acetone.

The sample is measured by ion chromatography, and the content of alkali metal and alkaline-earth metal is calculated from the spectrum amounts of alkali metal and alkaline-earth metal.

The measurement conditions for ion chromatograph are as follows.
Apparatus: Integrion RFiC (manufactured by Thermo)
Standard solution: Multication Standard Solution-II (manufactured by Kanto Chemical Co., Ltd.)
Column: CS-16 (manufactured by Thermo)
Column temperature: 40 °C (cation)
Mobile phase: 30 mM aqueous solution of methanesulfonic acid
Flow rate: 0.36 mL/min
Detector: Electrical conductivity
Injection amount: 10 μL
Analysis time: 27 minutes

In addition, the following standard solutions 1 to 3 are prepared as multiple standard samples of alkali metal and alkaline-earth metal, and calibration curves of the alkali metal and the alkaline-earth metal are created by performing measurement under the above-described conditions.
Standard solution 1—Standard solution described above
Standard solution 2—the above-described standard solution is diluted with ultrapure water such that the concentration is 0.50% by mass
Standard solution 3—the above-described standard solution is diluted with ultrapure water such that the concentration is 0.20% by mass

The content of alkali metal and alkaline-earth metal in the sample is obtained from the created calibration curve.

The thus obtained content of alkali metal and alkaline-earth metal is divided by each of the amounts of element thereof and is dealt as a molar mass of alkali metal and alkaline-earth metal comprised in the conductive elastic layer. The sum of the obtained content of alkali metal and alkaline-earth metal is defined as a sum of the content of alkali metal and alkaline-earth metal in the conductive elastic layer in the present disclosure. The sum of the above-described content is the number of moles of alkali metal and alkaline-earth metal per unit mass of the conductive elastic layer.

### Measurement of Surface Average Cell Diameter

A method of measuring the surface average cell diameter of the conductive elastic layer is as follows.

The measurement is performed using a laser microscope (“Shape Measurement Laser Microscope VK-8700” manufactured by Keyence Corporation or an equivalent analyzer).

The measurement regions are three regions corresponding to 10%, 50%, and 90% with respect to the entire length in the longitudinal direction from one end of the conductive elastic roller in the longitudinal direction. Measurement is performed at four locations corresponding to 0°, 90°, 180°, and 2700 in the circumferential direction of the conductive elastic roller for each measurement region, namely at a total of twelve points.

The observation field is defined as a region of 1.0 mm×1.4 mm. Twenty cells are selected for one observation region, and the diameter of the maximum inscribed circle inscribed in each cell skeleton section is measured. An arithmetic mean value of cell diameters at a total of twelve points is defined as a surface average cell diameter in the present disclosure.

### Differential Scanning Calorimetry of Conductive Elastic Layer

Differential scanning calorimetry of the conductive elastic layer is performed by the following method.

A differential scanning calorimeter (MDSC-2920, manufactured by TA Instruments) is used to perform measurement under the following conditions in accordance with ASTM D3418-82.

As a measurement sample, a conductive elastic layer is cut out from the conductive elastic roller, 10 mg precisely weighted therefrom is used, and this is placed in an aluminum pan. Also, an empty aluminum pan is used as a reference.

A measurement temperature range is set to be from 30 °C to 200 °C, and the temperature is raised from 30 °C to 200 °C at a temperature raising speed of 10 °C/min.

On a specific heat curve (that is, a DSC curve) obtained in the temperature raising process, a point at which the straight line at an equal distance in a vertical axis direction from a straight line extended from each of base line before and after a specific heat change and a curve at a stepwise change part of glass transition intersect is defined as a glass transition temperature (Tg). The temperature at which an endothermic peak is observed on the DSC curve is checked.

### EXAMPLES

The present disclosure will be further described in detail below by way of Examples, but these are not intended to limit the present invention in any way.

An ion compound that was a raw material of polyurethane comprised in the conductive elastic layer of the conductive elastic roller was synthesized.

### Synthesis of Compositions Containing Ion Compound

### Composition C-1

A stirring bar and 60 ml of tetrahydrofuran (THF, manufactured by Kanto Chemical Co., Inc.) were charged into an eggplant flask equipped with a Dimroth condenser, 24.0 g (0.60 mol) of sodium hydride (60% by mass, dispersed in liquid paraffin, manufactured by Tokyo Chemical Industry Co., Ltd.) was dispersed, and the eggplant flask was cooled in an ice bath. A solution of 10.2 g (0.15 mol) of imidazole (manufactured by Tokyo Chemical Industry Co., Ltd.) dissolved in 60 ml of THF was slowly added dropwise, the ice bath was then removed, and the mixture was stirred at room temperature for two hours. 47.6 g (0.38 mol) of 2-bromoethanol (manufactured by Tokyo Chemical Industry Co., Ltd.) was added thereto at room temperature, and the mixture was then heated under reflux at 70 °C for seven hours. The reaction liquid after the reaction was filtered, an insoluble content was washed off with THF, and the solvent of the obtained filtrate was distilled off under a reduced pressure. The thus obtained product was dissolved in 590.5 g of water, 179.3 g of ion exchange resin DOWEX 550A OH (manufactured by DuPont) was added thereto, and the mixture was stirred at room temperature for one hour.

The ion exchange resin was filtered, and an aqueous solution in which 27.2 g of imidodisulfurylfluoride lithium (manufactured by Aaron Chemicals) was dissolved in 379.6 g of water was added dropwise to the obtained aqueous solution for two hours. Note that during the dropwise addition, pH was checked at the same time, and the dropwise addition was stopped at pH 6.3. A solvent of the aqueous solution obtained was distilled off under a reduced pressure, thereby obtaining a composition C-1 in Example 1.

An ion compound 1 comprised in a composition C-1 is a compound represented by Formula (8) below. Physical properties of the composition C-1 are shown in Table 1.

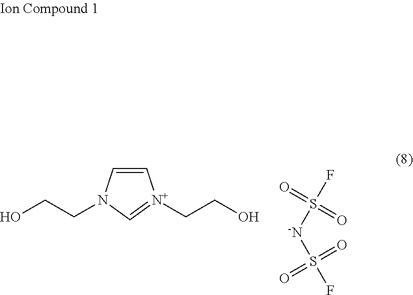

### Compositions C-2, C-3, and C-7

Compositions C-2, C-3, and C-7 were obtained similarly to the synthesis of Composition C-1 other than that anion raw materials and blending amounts thereof were changed as described in Table 1. Ion compounds 2, 3, and 7 comprised in the compositions C-2, C-3, and C-7 are compounds represented by combinations of the structural formulas representing the structures corresponding to the ion compounds and the anions described in Table 1. Physical properties of the compositions C-2, C-3, and C-7 are shown in Table 1.

TABLE 1

| Com- | | | Structure of ion compound | | | | | | | | | |
|---|---|---|---|---|---|---|---|---|---|---|---|---|
| po- | Anion raw material | | Nitrogen-containing | | | | | Content of alkali metal and alkaline- | | | | Vis- |
| si | | Mass | heteroaromatic | | | | | earth metal (ppm) | | | | cosity |
| tion- | Name | (g) | structure | R in structural formula | | | Anion | Lithium | Sodium | Potassium | Total | (mPa•s) |
| C-1 | Imidodisulfurylfluoride Lithium (manufactured by Aaron Chemicals) | 27.2 | 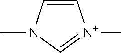 | R9 —C₂H₄—OH | R10 —C₂H₄—OH | | Bis(fluorosulfo- nyl)imide anion | 0.1 or less | 4500 | 0.1 or less | 4500 | 7.0 |
| C-2 | Tetrafluoroborate (manufactured by Fujifilm Wako Pure Chemical Corporation) | 13.4 | 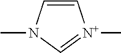 | R9 —C₂H₄—OH | R10 —C₂H₄—OH | | Tetrafluoroborate anion | 0.1 or less | 7000 | 0.1 or less | 7000 | 9.3 |
| C-3 | Thiocyanic acid (manufactured by A2B Chem) | 58.0 | 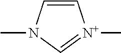 | R9 —C₂H₄—OH | R10 —C₂H₄—OH | | Thiocyanate anion | 0.1 or less | 6000 | 0.1 or less | 6000 | 8.3 |
| C-4 | Imidodisulfurylfluoride Lithium (manufactured by Aaron Chemicals) | 27.2 | 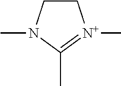 | R6 —C₂H₄—OH | R7 —CH₃ | R8 —CH₃ | Bis(fluorosulfo- nyl)imide anion | 0.1 or less | 8500 | 0.1 or less | 8500 | 12.2 |
| C-5 | Thiocyanic acid (manufactured by A2B Chem) | 58.0 | 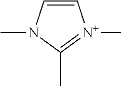 | R6 —C₂H₄—OH | R7 —CH₃ | R8 —CH₃ | Thiocyanate anion | 0.1 or less | 9000 | 0.1 or less | 9000 | 14.4 |
| C-6 | Lithium N,N-bis(fluorosulfo- nylimide)(manufactured by Mitsubishi Materials Electronic Chemicals Co., Ltd.) | 27.2 | 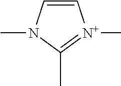 | R6 —C₂H₄—OH | R7 —C₂H₅ | R8 —CH₃ | Bis(fluorosulfo- nyl)imide anion | 26000 | 5000 | 0.1 or less | 31000 | — |
| C-7 | Bis(Irifluoromethanesulfo- nyl)imide(manufactured by Tokyo Chemical Industry Co., Ltd.) | 42.2 | 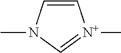 | R9 —C₂H₄—OH | R10 —C₂H₄—OH | | Bis(trifluoromethyl- sulfonyl)imide anion | 0.1 or less | 5000 | 0.1 or less | 5000 | 6.2 |
| C-8 | Potassium N,N-bis(fluorosulfo- nylimide)(manufactured by Mitsubishi Materials Electronic Chemicals Co., Ltd.) | 27.2 | 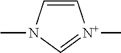 | R9 —C₂H₄—OH | R10 —C₂H₄—OH | | Bis(fluorosulfo- nyl)imide anion | 0.1 or less | 5000 | 56000 | 62000 | — |
| C-9 | Sodium thiocyanate (manufactured by Fujifilm Wako Pure Chemical Corporation) | 58.0 | 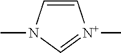 | R9 —C₂H₄—OH | R10 —C₂H₄—OH | | Thiocyanate anion | 0.1 or less | 56000 | 0.1 or less | 56000 | — |

| | | | | | | | |
|---|---|---|---|---|---|---|---|
| C-10 | Details are described in the specification. | Bis(trifluoromethyl- | 0.1 or | 7000 | 0.1 or less | 7000 | 9.3 |
| | | sulfonyl)imide anion | less | | | | |
| C-11 | Details are described in the specification. | Bis(trifluoromethyl- | 0.1 or | 7000 | 0.1 or less | 7200 | 9.6 |
| | | sulfonyl)imide anion | less | | | | |

In the table, “viscosity” indicates a viscosity of a liquid composition at 23 °C. Since the compositions C-6, C-8, and C-9 were solid, the viscosities thereof were not measured.

### Composition C-4

15.0 g of 5-methylpyrazine-2-methanol (manufactured by Sigma-Aldrich CO. LLC) and 9.2 g of sodium hydride (60%, dispersed in liquid paraffin) (manufactured by Tokyo Chemical Industry Co., Ltd.) were dissolved in 80.0 g of tetrahydrofuran. 18.9 g of methyl iodide (manufactured by Tokyo Chemical Industry Co., Ltd.) dissolved in 80.0 g of tetrahydrofuran was added dropwise thereto at room temperature over 30 minutes, and then heated under reflux at 85 °C for 12 hours.

Next, 100 ml of water was added to the reaction solution, the reaction liquid after the reaction was filtered, an insoluble matter was washed off with THF, and the solvent of the resultant filtrate was distilled away under a reduced pressure. The thus obtained product was dissolved in 590.5 g of water, 179.3 g of an ion exchange resin DOWEX 550A OH (manufactured by DuPont) was added thereto, and the mixture was stirred at room temperature for 1 hour.

The ion exchange resin was filtered, and an aqueous solution obtained by dissolving 27.2 g of imidodisulfurylfluoride lithium (Aaron Chemicals) in 379.6 g of water was added dropwise to the thus obtained aqueous solution over 2 hours. Note that pH was checked at the same time during the dropwise addition and the dropwise addition was ended at pH 6.3. The solvent of the thus obtained aqueous solution was distilled away under a reduced pressure, thereby obtaining a composition C-4. An ion compound 4 comprised in the composition C-4 is a compound represented by a combination of the structural formula representing the structure corresponding to the ion compound and the anion described in Table 1. Physical properties of the composition C-4 are shown in Table 4.

### Composition C-5

A composition C-5 is obtained similarly to the synthesis of the composition C-4 other than that an anion raw material and the blending amount thereof were changed as described in Table 1.

An ion compound 5 comprised in the composition C-5 is a compound represented by a combination of the structural formula representing the structure corresponding to the ion compound and the anion described in Table 1. Physical properties of the composition C-5 are shown in Table 1.

### Composition C-6

15.0 g of 2-methylimidazole-1-ethanol (manufactured by Sigma-Aldrich CO. LLC) and 9.2 g of sodium hydride (60%, dispersed in liquid paraffin) (manufactured by Tokyo Chemical Industry Co., Ltd.) were dissolved in 80.0 g of tetrahydrofuran. 14.5 g of ethyl iodide (manufactured by Showa Chemical Industry Co., Ltd.) dissolved in 80.0 g of tetrahydrofuran was added dropwise thereto at room temperature for 30 minutes, and the mixture was then heated under reflux at 85 °C for 12 hours.

Next, 100 ml of water was added to a reaction solution, and the solvent was distilled off under a reduced pressure. 200 ml of ethanol was added to a residue and stirred at room temperature, an insoluble material was removed by celite filtration, and the solvent was then distilled off again under a reduced pressure.

The obtained product was dissolved in 100 ml of pure water, 38.2 g of anion exchange reagent (hereinafter, referred to as an “anion raw material”) was added thereto, and the mixture was stirred at room temperature for one hour. As the anion raw material, lithium N,N-bis(trifluoromethanesulfonyl)imide (trade name: EF-N115, manufactured by Mitsubishi Materials Electronic Chemicals Co., Ltd.) was used. 100 ml of ethyl acetate was added to a reaction solution, and an organic layer was washed using 80 g of ion exchange water three times.

Next, a composition C-6 was obtained by distilling away ethyl acetate under a reduced pressure. An ion compound 6 comprised in the composition C-6 is a compound represented by a combination of the structural formula representing the structure corresponding to the ion compound and the anion described in Table 1. The composition C-6 was a solid. Physical properties of the composition C-6 are shown in Table 1.

### Composition C-8

15.0 g of imidazole (manufactured by Nippon Synthetic Chemical Industry Co., Ltd.) and 9.2 g of sodium hydride (60%, dispersed in liquid paraffin) (manufactured by Tokyo Chemical Industry Co., Ltd.) were dissolved in 60.0 g of tetrahydrofuran in a nitrogen atmosphere. 60.7 g of 2-bromoethanol (manufactured by Tokyo Chemical Industry Co., Ltd.) dissolved in 80.0 g of tetrahydrofuran was added dropwise thereto at room temperature over 30 minutes, and the mixture was then heated under reflux at 85 °C for 12 hours.

Next, 100 ml of water was added to a reaction solution, and the solvent was distilled away under reduced pressure. 200 ml of ethanol was added to a residue and stirred at room temperature, an insoluble material was removed by celite filtration, and the solvent was then distilled away again under reduced pressure.

The thus obtained product was dissolved in 200 ml of pure water, and 27.2 g of potassium N,N-bis(fluorosulfonylimide) (manufactured by Mitsubishi Materials Electronic Chemicals Co., Ltd.) was added thereto as an anion raw material, and the mixture was stirred at room temperature for 1 hour. 200 ml of ethyl acetate was added to a reaction solution, and an organic layer was washed using 120 g of ion-exchanged water three times. Next, a composition C-8 was obtained by distilling away ethyl acetate under a reduced pressure.

An ion compound 8 comprised in the composition C-8 is a compound represented by a combination of the structural formula representing the structure corresponding to the ion compound and the anion described in Table 1. Physical properties of the composition C-8 are shown in Table 1.

### Composition C-9

A composition C-9 was obtained similarly to the composition C-8 other than that the anion raw material and the blending amount thereof were changed as described in Table 1.

An ion compound 9 comprised in the composition C-9 is a compound represented by a combination of the structural formula representing the structure corresponding to the ion compound and the anion described in Table 1. Physical properties of the composition C-9 are shown in Table 1.

### Composition C-10

A stirring bar was placed in a three-necked flask equipped with a Dimroth condenser, 30 g of 2-pyridineethanol (manufactured by Tokyo Chemical Industry Co., Ltd.) as the tertiary amine, 200 ml (1.25 mol/l) of ethyl acetate, and 79.3 g of N-hydroxyethylbis(trifluoromethylsulfonyl)imide as an ester compound were introduced thereinto, and the mixture was refluxed in a nitrogen atmosphere for 20 hours. The reaction solution after the reaction was cooled and was divided into ethyl acetate and water. An organic layer was collected, was dehydrated with magnesium sulfate, and was filtered and dried, thereby obtaining a composition C-10 comprising the ion compound 10. Physical properties of the composition C-10 are shown in Table 1.

### Composition C-11

A stirring bar was placed in a three-necked flask equipped with a Dimroth condenser, 30.0 g of 1-hydroxyethyl-2-hydroxymethylimidazole as tertiary amine, 200 ml (1.25 mol/l) of ethyl acetate, and 68.7 g of N-methylbis(trifluoromethylsulfonyl)imide as an ester compound were introduced thereinto, and the mixture was refluxed in a nitrogen atmosphere for 20 hours. The reaction solution after the reaction was cooled and was divided into ethyl acetate and water. An organic layer was collected, was dehydrated with magnesium sulfate, and was filtered and dried, thereby obtaining a composition C-11 comprising the ion compound 11. Physical properties of the composition C-11 are shown in Table 1.

### Foam Conductive Elastic Roller

### Manufacturing of Foam Conductive Elastic Roller 1

A core metal having an outer diameter of 5 mm and made of stainless steel (SUS304) as a base substrate was arranged in a mold including a cylindrical member with an inner diameter of 16.5 mm, an upper piece member, and a lower piece member. A release agent was applied to the inner surface of the mold die in advance.

The following materials (A), (B), (C), and (E) to (I) were blended, and the urethane composition obtained by the blended materials was poured into a cavity formed in the mold.
(A): Composition C-1: 3.0 parts by mass
(B): Polyol A (polyethylene propylene ether triol with a number average molecular weight of 2000, trade name: ACTCOL EP-550N; manufactured by Mitsui Chemicals, Inc.): 60.0 parts by mass
(C) Polyol B (polyethylene propylene ether triol with a number average molecular weight of 6000, trade name: ACTCOL EP-950P; manufactured by Mitsui Chemicals, Inc.) 40.0 parts by mass
(E) Polyisocyanate admixture (containing NCO %=45, and MDI=20%, trade name: COSMONATE TM20; manufactured by Mitsui Chemicals, Inc.): 24.4 parts by mass
(F): Silicone foam stabilizer (trade name: SRX274C, manufactured by Dow Corning Toray Co., Ltd.): 1.0 parts by mass
(G): Tertiary amine catalyst A (a mixture of bis(2-dimethylaminoethyl)ether and dipropylene glycol, trade name: TOYOCAT-ET, manufactured by Tosoh Corporation): 0.3 parts by mass
(H): Tertiary amine catalyst B (mixture of triethylenediamine and dipropylene glycol, trade name: TEDA-L33, manufactured by Tosoh Corporation): 0.2 parts by mass
(I): Blowing agent (water): 1.4 parts by mass

Subsequently, a mold was heated to 70 °C, a urethane rubber composition was foamed and cured for 10 minutes, and a substrate with a foam elastic layer formed on a peripheral surface thereof was released from the mold. A foam conductive elastic roller 1 having, at the outer periphery of the substrate, the foam conductive elastic layer with a diameter of 16.5 mm was produced. Physical properties of the foam conductive elastic roller 1 are described in Table 2.

### Manufacturing of Foam Conductive Elastic Rollers 2 to 11 and Manufacturing of Comparative Foam Conductive Elastic Rollers 1 to 6

Foam conductive elastic rollers 2 to 11 and comparative foam conductive elastic rollers 1 to 6 were manufactured similarly to the foam conductive elastic roller 1 other than that the types of compositions and the blending amounts of polyol A and polyol B were changed as shown in Table 2. Physical properties of the foam conductive rollers 2 to 11 and the comparative foam conductive elastic rollers 1 to 6 are described in Table 2.

TABLE 2

| | Composition | | Polyol A | Polyol B | | | | Surface | Sum of content | |
|---|---|---|---|---|---|---|---|---|---|---|
| | | Number | Number | Number | | | | average | of alkali metal | Endo- |
| | | of | of | of | Solubility parameter | | | cell | and alkaline- | thermic |
| | | blended | blended | blended | (J/cm)³)^{0.5}) | | | diameter | earth metal | peak |
| Foam conductive elastic roller | Type | parts | parts | parts | Polyurethane | Anion | Difference | (μm) | (mol/g) | (°C) |
| Foam conductive elastic roller 1 | C-1 | 3 | 60 | 40 | 8.29 | 9.18 | 0.89 | 250 | 0.1 × 10⁻⁶ | 55 |
| Foam conductive elastic roller 2 | C-2 | 3 | 60 | 40 | 8.29 | 9.52 | 1.23 | 250 | 0.3 × 10⁻⁶ | 48 |
| Foam conductive elastic roller 3 | C-3 | 3 | 60 | 40 | 8.29 | 9.84 | 1.55 | 250 | 0.2 × 10⁻⁶ | 46 |
| Foam conductive elastic roller 4 | C-1 | 3 | 80 | 20 | 8.05 | 9.18 | 1.13 | 250 | 0.1 × 10⁻⁶ | 70 |
| Foam conductive elastic roller 5 | C-1 | 3 | 90 | 10 | 7.90 | 9.18 | 1.28 | 250 | 0.1 × 10⁻⁶ | 75 |
| Foam conductive elastic roller 6 | C-1 | 3 | 90 | 10 | 7.90 | 9.18 | 1.28 | 100 | 0.1 × 10⁻⁶ | 75 |
| Foam conductive elastic roller 7 | C-1 | 3 | 90 | 10 | 7.90 | 9.18 | 1.28 | 500 | 0.1 × 10⁻⁶ | 75 |
| Foam conductive elastic roller 8 | C-1 | 3 | 90 | 10 | 7.90 | 9.18 | 1.28 | 80 | 0.1 × 10⁻⁶ | 75 |
| Foam conductive elastic roller 9 | C-4 | 3 | 90 | 10 | 7.90 | 9.18 | 1.28 | 80 | 0.4 × 10⁻⁶ | 75 |
| Foam conductive elastic roller 10 | C-5 | 3 | 90 | 10 | 7.90 | 9.84 | 1.94 | 80 | 1.0 × 10⁻⁶ | 72 |
| Foam conductive elastic roller 11 | C-4 | 3 | 0 | 100 | 8.54 | 9.18 | 0.64 | 80 | 0.4 × 10⁻⁶ | 40 |
| Comparative foam | C-6 | 3 | 90 | 10 | 7.90 | 9.18 | 1.28 | 80 | 2.0 × 10⁻⁶ | 25 |
| conductive elastic roller 1 | | | | | | | | | | |
| Comparative foam | C-7 | 3 | 0 | 100 | 8.54 | 8.85 | 0.31 | 80 | 0.1 × 10⁻⁶ | 35 |
| conductive elastic roller 2 | | | | | | | | | | |
| Comparative foam | C-8 | 3 | 90 | 10 | 7.90 | 9.18 | 1.28 | 250 | 5.0 × 10⁻⁶ | 22 |
| conductive elastic roller 3 | | | | | | | | | | |
| Comparative foam | C-9 | 3 | 90 | 10 | 7.90 | 9.84 | 1.94 | 250 | 7.3 × 10⁻⁶ | 16 |
| conductive elastic roller 4 | | | | | | | | | | |
| Comparative foam | C-10 | 3 | 60 | 40 | 8.29 | 8.85 | 0.56 | 250 | 0.1 × 10⁻⁶ | 28 |
| conductive elastic roller 5 | | | | | | | | | | |
| Comparative foam | C-11 | 3 | 60 | 40 | 8.29 | 8.85 | 0.56 | 250 | 0.1 × 10⁻⁶ | 28 |
| conductive elastic roller 6 | | | | | | | | | | |

In the table, “difference” in the solubility parameter indicates a difference in solubility parameters between polyurethane and the anion.

The endothermic peak indicates a temperature at which an endothermic peak was observed in differential scanning calorimetry of the conductive elastic layer. One endothermic peak was observed at the temperatures shown in Table 2 in all the rollers.

In all of the foam conductive elastic rollers 1 to 8 using the compositions C-1 to C-3, polyurethane comprised in the foam conductive elastic layers had the cationic structure represented by Structural Formula (1) above. d1 in Structural Formula (1) was 0, both Z1 and Z2 were the structure represented by Structural Formula (Z101) above, and R101 was —C₂H₄—.

In all of the foam conductive elastic rollers 9 to 11 using the compositions C-4 and C-5, polyurethane comprised in the foam conductive elastic layers had the cationic structure represented by Structural Formula (4) above. d1 in Structural Formula (4) was 1, Z2 was the structure represented by Structural Formula (Z101) above, and R101 was —C₂H₄—.

### Conductive Elastic Roller

Conductive rollers in which the elastic layers were not foamed were produced by the following method.

### Creation of Elastic Roller D-1

A primer (trade name: DY35-051; manufactured by Dow Corning Toray Co., Ltd.) was applied to a stainless steel (SUS304) core metal with a diameter of 6 mm and a full length of 278.9 mm and was baked in an oven heated to a temperature of 180 °C for 20 minutes, thereby obtaining a substrate. The substrate was placed in a mold, and an addition-type silicone rubber composition obtained by mixing the materials listed below was poured into a cavity formed in a mold.
Liquid silicone rubber material (trade name, SE6724A/B; manufactured by Dow Corning Toray Co., Ltd.): 100 parts by mass
Carbon black (trade Name: TOKABLACK #4300, manufactured by Tokai Carbon Co., Ltd.): 15 parts by mass
Silica powder as a heat resistance-imparting agent: 0.2 part by mass
Platinum catalyst; 0.1 part by mass

Subsequently, the mold was heated at a temperature of 150 °C for 15 minutes to vulcanize and cure the silicone rubber. After the substrate with the cured silicone rubber layer formed on the peripheral surface thereof was removed from the mold, the substrate was further heated at a temperature of 180 °C for 1 hour to complete the curing reaction of the silicone rubber layer. An elastic roller D-1 with a silicon rubber elastic layer with a diameter of 12 mm formed on the outer periphery of the substrate was thus produced.

### Manufacturing Example of Isocyanate Group-Terminated Prepolymer Synthesis of Isocyanato Group-Terminated Prepolymer B-1

The reaction vessel was treated as a nitrogen atmosphere, and 38 parts by mass of isocyanate D-1 (Polymeric MDI (trade name: Millionate MR200, manufactured by Tosoh Corporation) was added into the reaction vessel. Next, 100 parts by mass of polyol F-1 (poly(tetramethylene glycol) (trade name: PTMG2000; manufactured by Mitsubishi Chemical Corporation)) was gradually added dropwise into the reaction vessel with the temperature in the reaction vessel maintained at 65 °C. After completion of the dropwise addition, the reaction was carried out at a temperature of 65 °C for 2 hours. The thus obtained reaction mixture was cooled to room temperature, and was diluted with methyl ethyl ketone (hereinafter, referred to as “MEK”) 50 parts by mass, thereby obtaining a solution of isocyanate group-terminated prepolymer B-1 in which the content of isocyanate group was 3.4% by mass.

### Example of Manufacturing of Surface Layer Forming Coating

Materials shown below were stirred and mixed as materials for the surface layer.
Isocyanate group-terminated prepolymer B-1: 85 parts by mass
Poly(tetramethylene glycol) (trade name; OTMG2000; manufactured by Mitsubishi Chemical Corporation, hydroxyl value 56 mgKOH/g): 56 parts by mass
Composition C-1: 3 parts by mass
90 parts by mass of urethane resin fine particles (trade name, Art Pearl C-400; manufactured by Negami Chemical Industrial Co., Ltd.)

Next, after MEK was added so that the total solid content ratio became 30% by mass, zirconia beads (center particle diameter of 0.8 mm) were poured in such a manner that the mass became twice the mass of the mixture liquid, and the mixture was mixed using a sand mill with an inner wall made of zirconia. Furthermore, MEK was used for the preparation to achieve a viscosity of 10 cps to 13 cps, thereby preparing a surface layer forming coating.

### Manufacturing of Conductive Elastic Roller 12

The elastic roller D-1 created in advance was immersed in the coating material 1 prepared in advance, a coating of the coating material is formed on the surface of the elastic layer of the elastic roller D-1, and the coating was dried. A surface layer with a film thickness of 15 m was provided on the outer periphery of the elastic layer by further performing heating processing at a temperature of 160 °C for 1 hour, thereby manufacturing a conductive elastic roller 12. Physical properties of the conductive elastic roller 12 are shown in Table 3.

### Manufacturing of Comparative Conductive Elastic Roller 7

A comparative conductive elastic roller 7 was manufactured similarly to the manufacturing of the conductive elastic roller 12 other than that the composition C-1 was changed to the composition C-10. Physical properties of the comparative conductive elastic roller 7 are shown in Table 3.

TABLE 3

| | | | | | | Sum of content |
|---|---|---|---|---|---|---|
| | | | | | | of alkali |
| | Liquid composition | | Solubility parameter | | | metal and |
| | | Number of | (J/cm)³)^{0.5}) | | | alkaline-earth |
| Conductive elastic roller | Type | blended parts | Polyurethane | Anion | Difference | metal (mol/g) |
| Conductive elastic roller 12 | C-1 | 3 | 8.29 | 9.18 | 0.89 | 0.1 × 10⁻⁶ |
| Comparative conductive | C-10 | 3 | 8.29 | 8.85 | 0.56 | 0.1 × 10⁻⁶ |
| elastic roller 7 | | | | | | |

### Example 1

### Electric Resistance Values Before and After Electrification Test

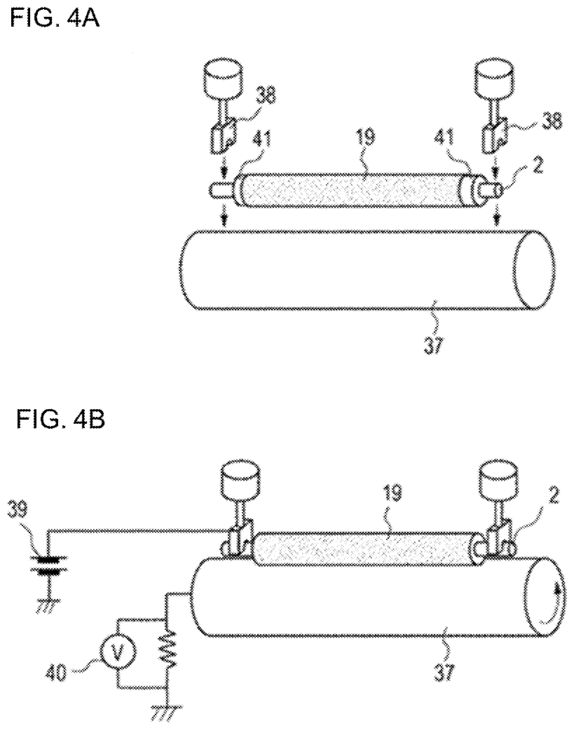

After the foam conductive elastic roller 1 was left to stand for 24 hours in a low-temperature low-humidity environment at a temperature of 15 °C and a relative humidity of 10%, the electric resistance value of the foam conductive elastic roller 1 was evaluated with an apparatus shown in FIGS. 4A and 4B.

An outline of the above-described apparatus is described below. Note that in the following description, a portion where the conductive elastic roller is described may be replaced with a foam conductive elastic roller.

As illustrated in FIG. 4A, non-conductive nip regulating members 41 were mounted on both ends of the substrate 2. In addition, a columnarl metal 37 having a diameter of 30 mm was rotated while both ends of the conductive substrate 2 were pressed at a load of 4.9 N, respectively, through conductive bearings 38, and the conductive elastic roller 19 was driven to rotate at a speed of 32 rpm.

Next, as illustrated in FIG. 4B, a voltage of −100 V was applied with a high-voltage power source 39, and a potential difference between both ends of a resistor having a known resistance value (the resistance value was lower by two-digit order or more than the resistance value of the conductive elastic roller 19) disposed between the columnar metal 37 and the ground was measured. A voltmeter 40 (trade name: 189TRUE RMS MULTIMETER, manufactured by Fluke Corporation) was used to measure the potential difference.

From the measured potential difference and the resistance value of the resistor, a current flowing into the columnar metal 37 through the conductive elastic roller 19 was obtained by calculation. In addition, the electric resistance value of the conductive elastic roller was obtained by dividing the applied voltage of 100 V by the obtained current. At this time, sampling was performed for 3 seconds from 2 seconds after the voltage application, and a value calculated from an average value thereof was used for the measurement of the potential difference.

By such a method, the electric resistance value of the foam conductive elastic roller 1 was measured, and it was defined as an electric resistance value before the electrification test.

Thereafter, the above-described apparatus was used to apply the voltage of −100 V and distribute power to the conductive elastic roller driven to rotate for 2 hours, and the measured electric resistance value was obtained. The measured value was defined as an electric resistance value of the conductive elastic roller 1 after the electrification test. The lower electric resistance value after the electrification test means a more satisfactory result. Evaluation results of the foam conductive elastic roller 1 are shown in Table 4.

### Durability Evaluation

A method of evaluating images will be described below.

A modified machine of LBP-7600C (manufactured by Canon Inc.), which was a commercially available laser printer, was used as an electrophotographic image forming apparatus. As a modification point, the number of output sheets per unit time was set to 50 sheets/minute for A4-size paper in order to perform evaluation in a high-speed process. As a process cartridge, a commercially available developer cartridge 318 (black) (manufactured by Canon Inc.) was used, and the toner supply roller was replaced with the foam conductive elastic roller 1. At this time, the filling amount of the developer was adjusted to 100 g. Note that yellow, cyan, and magenta cartridges were respectively inserted into the yellow, cyan, and magenta stations, with product toners removed therefrom and with a remaining toner amount detection mechanism disabled, and the evaluation was then conducted.

A prepared process cartridge was installed in the main body of the electrophotographic image forming apparatus, and was left to stand for 24 hours in a low-temperature low-humidity environment at a temperature of 15 °C and a relative humidity of 10%. In the same environment, an image where an alphabet letter “E” with a size of 4 points was 2% in print percentage with respect to the area of the A4 size paper sheet was continuously output on A4 evaluation paper sheets (GF-C081, manufactured by Canon Inc.). This was repeated up to 50000 sheets. At this time, the toner was charged when the remaining amount of toner decreased to 50 g so as to achieve the toner amount of 100 g. In this manner, it was possible to severely evaluate a decrease in fogging density due to a change in resistance of the conductive elastic roller in the low-temperature low-humidity environment.

Solid black image was continuously output on three sheets at the timing of an initial stage of durability and after printing on 50000 sheets. An image density in a region corresponding to upper 10% of the first black solid image and an image density in a region corresponding to lower 10% of the third sheet were measured by a spectrodensitometer (trade name: 500 spectrodensitometer, manufactured by X-Rite), thereby obtaining density values of the solid black image. A difference between an average of image densities at five points in the region corresponding to upper 10% and an average of image densities at five points in the region corresponding to lower 10% was defined as an evaluation result of solid image followability. A smaller solid image followability value means a more satisfactory result. In a case where the electric resistance of the conductive elastic roller in the initial stage is large, the solid image followability value tends to become large in the initial evaluation. Also, in a case where the electric resistance of the conductive elastic roller after the electrification test is large, the solid image followability value tends to become large in the evaluation after the printing on 50000 sheets.

Evaluation results of the conductive elastic roller are shown in Table 4.

### Examples 2 to 11

In Examples 2 to 11, measurement and evaluation were carried out similarly to Example 1 other than that the conductive elastic roller was changed to the foam conductive elastic rollers 2 to 11 described in Table 2. Evaluation results are described in Table 4.

### Example 12

In Example 12, a conductive elastic roller 12 described in Table 3 was used as a developing roller, and the following evaluation was carried out.

### Electric Resistance Values Before and After Electrification Test

The electric resistance values before and after the electrification test were evaluated similarly to Example 1.

### Durability Evaluation

A method of evaluating images will be described below.

A modified machine of a commercially available laser printer LBP-7600C (manufactured by Canon Inc.) was used as the electrophotographic image forming apparatus. As a modification point, the number of output sheets per unit time was set to 50 sheets/min for A4-size paper in order to perform the evaluation in a high-speed process. As a process cartridge, a commercially available developer cartridge 318 (black) (manufactured by Canon Inc.) was used, and the developing roller was replaced with the conductive elastic roller 12. At this time, the filling amount of the developer was adjusted to be 100 g. Note that yellow, cyan, and magenta cartridges were respectively inserted into yellow, cyan, and magenta stations, with the product toners removed therefrom and with the remaining toner detection mechanism disabled, and the evaluation was then performed.

A prepared process cartridge was installed in the main body of the electrophotographic image forming apparatus, and was left to stand for 24 hours in a low-temperature low-humidity environment at a temperature of 15 °C and a relative humidity of 10%. In the same environment, an image where an alphabet letter “E” with a size of 4 points was 2% in print percentage with respect to the area of the A4 size paper sheet was continuously output on A4 evaluation paper sheets (GF-C081, manufactured by Canon Inc.). This was repeated up to 50,000 sheets. At this time, the toner was charged when the remaining amount of toner decreased to 50 g so as to achieve the toner amount of 100 g. In this manner, it was possible to severely evaluate occurrence of fog due to a change in resistance of the conductive elastic roller in the low-temperature low-humidity environment.

A solid white image was continuously output on three sheets at the timing of an initial stage of durability and after printing on 50000 sheets. A reflection density meter (trade name: TC-6DS/A manufactured by Tokyo Denshoku Technical Center) was used to measure a reflection density R1 of a recording material before image formation and a reflection density R2 on a third recording material on which the solid white image was output, and the amount of increase (R2−R1) in reflection density was defined as a “fogging value” of the developer bearing member. As the reflection density, measurement was carried out over the entire image printing region of each recording material, and the maximum value thereof was employed.

Note that a smaller fogging value indicates a better quality, and the toner is typically not transferred onto the transfer paper on which a solid white image is formed. In a case where the amount of charge of the developer is insufficient, the developer moves onto the photosensitive member even during formation of a solid white image and is further transferred onto the transfer paper sheet, which leads to an increase in fogging value. In a case where the initial electric resistance of the conductive elastic roller is large, the fogging density tends to become large in the initial evaluation. Furthermore, in a case where the electric resistance of the conductive elastic roller after the electric conduction test is large, the fogging density value tends to become large in the evaluation after printing on 50000 sheets.

Evaluation results of the conductive elastic roller 12 are shown in Table 5.

### Evaluation of Comparative Conductive Elastic Roller 7

Evaluation was carried out similarly to the evaluation of the conductive elastic roller other than that the comparative conductive elastic roller 7 was used in the evaluation of the conductive elastic roller 12. Evaluation results of the comparative conductive elastic roller 7 are shown in Table 5.

TABLE 4

| | | Electric resistance | | Solid image | |
|---|---|---|---|---|---|
| | | value (Ω) | | density difference | |
| | | | After power | | After |
| | | | distribution | | durability |
| Example | Conductive elastic roller | Initial | test | Initial | test |
| Example 1 | Foam conductive elastic roller 1 | 8.3 × 10⁶ | 6.3 × 10⁷ | 0.01 | 0.12 |
| Example 2 | Foam conductive elastic roller 2 | 1.2 × 10⁷ | 7.3 × 10⁷ | 0.03 | 0.24 |
| Example 3 | Foam conductive elastic roller 3 | 2.5 × 10⁷ | 7.1 × 10⁷ | 0.02 | 0.22 |
| Example 4 | Foam conductive elastic roller 4 | 1.5 × 10⁷ | 6.9 × 10⁷ | 0.02 | 0.2 |
| Example 5 | Foam conductive elastic roller 5 | 3.3 × 10⁷ | 7.3 × 10⁷ | 0.04 | 0.28 |
| Example 6 | Foam conductive elastic roller 6 | 2.2 × 10⁷ | 7.4 × 10⁷ | 0.04 | 0.29 |
| Example 7 | Foam conductive elastic roller 7 | 2.3 × 10⁷ | 7.6 × 10⁷ | 0.05 | 0.27 |
| Example 8 | Foam conductive elastic roller 8 | 2.3 × 10⁷ | 7.7 × 10⁷ | 0.06 | 0.29 |
| Example 9 | Foam conductive elastic roller 9 | 2.4 × 10⁷ | 9.3 × 10⁷ | 0.04 | 0.34 |
| Example 10 | Foam conductive elastic roller 10 | 2.3 × 10⁷ | 9.7 × 10⁷ | 0.08 | 0.35 |
| Example 11 | Foam conductive elastic roller 11 | 2.3 × 10⁷ | 9.4 × 10⁷ | 0.07 | 0.36 |
| Comparative Example 1 | Comparative foam conductive elastic roller 1 | 8.3 × 10⁶ | 5.2 × 10⁹ | 0.01 | 0.55 |
| Comparative Example 2 | Comparative foam conductive elastic roller 2 | 5.3 × 10⁶ | 9.5 × 10⁹ | 0.02 | 0.62 |
| Comparative Example 3 | Comparative foam conductive elastic roller 3 | 8.8 × 10⁶ | 4.3 × 10⁹ | 0.01 | 0.52 |
| Comparative Example 4 | Comparative foam conductive elastic roller 4 | 2.3 × 10⁷ | 6.6 × 10⁹ | 0.07 | 0.57 |
| Comparative Example 5 | Comparative foam conductive elastic roller 5 | 8.3 × 10⁶ | 2.2 × 10⁹ | 0.02 | 0.51 |
| Comparative Example 6 | Comparative foam conductive elastic roller 6 | 8.3 × 10⁶ | 5.2 × 10⁹ | 0.05 | 0.58 |

TABLE 5

| | | Electric resistance value | | Fogging | |
|---|---|---|---|---|---|
| | | | After power | | After |
| | Conductive elastic roller | Initial | distribution test | Initial | durability test |
| Example 12 | Conductive elastic roller 12 | 8.4 × 10⁶ | 1.2 × 10⁸ | 0.5 | 2.4 |
| Comparative | Comparative conductive elastic roller 7 | 8.5 × 10⁶ | 9.8 × 10⁹ | 0.8 | 5.5 |
| Example 7 | | | | | |

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-070588, filed Apr. 22, 2025, which is hereby incorporated by reference herein in its entirety.

What is claimed is:

1. A conductive elastic roller comprising:
a conductive substrate; and a conductive elastic layer on the substrate, wherein
the conductive elastic layer comprises polyurethane comprising a urethane bond and an ether bond, and an anion,
the polyurethane comprises at least one selected from the group consisting of a cationic structure represented by Structural Formula (1) below, a cationic structure represented by Structural Formula (2) below, and a cationic structure represented by Structural Formula (3) below,
the anion comprises at least one selected from the group consisting of (fluorosulfonyl)imide anion, (fluorosulfonate)imide anion, fluoroborate anion, fluorophosphate anion, dicyanamide anion, and thiocyanate anion, and
a sum of a content of alkali metal and a content of alkaline-earth metal in the conductive elastic layer is 1.0×10⁻⁶ mol/g or less: 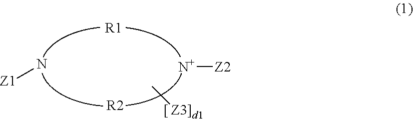
where in Structural Formula (1), R1 and R2 represent a hydrocarbon group needed to form a nitrogen-containing heteroaromatic 5-membered ring together with a nitrogen atom to which each of R1 and R2 is bonded, and d1 represents an integer which is 0 or 1. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, at least one of Z1 to Z3 is the structure represented by Structural Formula (Z101) below, the structure represented by Structural Formula (Z102) below, or the structure represented by Structural Formula (Z103) below: 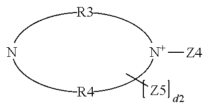
where in Structural Formula (2), R3 and R4 represent a hydrocarbon group needed to form a nitrogen-containing heteroaromatic 6-membered ring together with a nitrogen atom to which each of R3 and R4 is bonded, d2 represents an integer which is from 0 to 2, and Z5 may be the same or differ when d2 is 2. Z4 and Z5 each independently represent the structure represented by Structural Formula (Z101) below, the structure represented by Structural Formula (Z102), the structure represented by Structural Formula (Z103), a hydrogen atom, or a hydrocarbon group having 1 to 4 carbon atoms. However, at least one of Z4 and Z5 is the structure represented by Structural Formula (Z101) below, the structure represented by Structural Formula (Z102) below, or the structure represented by Structural Formula (Z103) below: 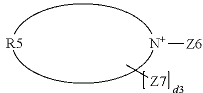
where in Structural Formula (3), R5 represents a hydrocarbon group needed to form a nitrogen-containing heteroaromatic ring together with a nitrogen atom to which R5 is bonded, and d3 represents an integer which is 0 or 1. Z6 and Z7 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, at least one of Z6 and Z7 is the structure represented by Structural Formula (Z101) below, the structure represented by Structural Formula (Z102) below, or the structure represented by Structural Formula (Z103) below: 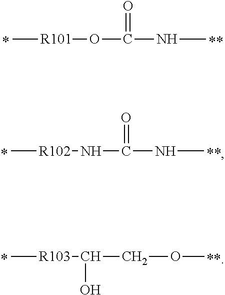
where in Structural Formulas (Z101), (Z102), and (Z103), R101, R102, and R103 each independently represent a linear or branched divalent hydrocarbon group. The symbol “*” represents a bonding portion with a nitrogen atom or a carbon atom constituting the nitrogen-containing heteroaromatic 5-membered ring of Structural Formula (1), a bonding portion with a nitrogen atom or a carbon atom constituting the nitrogen-containing heteroaromatic 6-membered ring of Structural Formula (2), or a bonding portion with a nitrogen atom or a carbon atom constituting the nitrogen-containing heteroaromatic ring of Structural Formula (3). The symbol “**” represents a bonding portion with a carbon atom in a polymer chain of the polyurethane.

2. The conductive elastic roller according to claim 1, wherein
the anion comprises at least bis(fluorosulfonyl)imide anion.

3. The conductive elastic roller according to claim 1, wherein
a difference between a solubility parameter of the polyurethane and a solubility parameter of the anion is 0.60 to 2.00 ((J/cm)³)^{0.5}.

4. The conductive elastic roller according to claim 1, wherein
the cationic structure is a structure represented by Structural Formula (4) below: 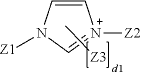
where in Structural Formula (4), d1 represents an integer which is 0 or 1. Z1 to Z3 each independently represent the structure represented by Structural Formula (Z101), the structure represented by Structural Formula (Z102), the structure represented by Structural Formula (Z103), a hydrogen atom, or a hydrocarbon group having 1 to 4 carbon atoms. However, at least one of Z1 to Z3 is the structure represented by Structural Formula (Z101), the structure represented by Structural Formula (Z102), or the structure represented by Structural Formula (Z103).

5. The conductive elastic roller according to claim 1, wherein
the conductive elastic layer is a foam conductive elastic layer.

6. The conductive elastic roller according to claim 1, wherein
the conductive elastic layer is a foam conductive elastic layer, and
a surface average cell diameter of the foam conductive elastic layer is 80 to 500 μm.

7. The conductive elastic roller according to claim 1, wherein
when the conductive elastic layer is measured by a differential scanning calorimeter (DSC), at least one endothermic peak is present within a range of 40 to 70 °C in a specific heat curve when a temperature is raised from 30 °C to 200 °C at a temperature raising speed of 10 °C/min.

8. A method of manufacturing a conductive elastic roller,
the conductive elastic roller comprising a conductive substrate and a conductive elastic layer on the substrate,
the conductive elastic layer comprising polyurethane having a urethane bond and an ether bond, and an anion,
the polyurethane comprising a cationic structure represented by Structural Formula (1) below,
the anion comprising at least one selected from the group consisting of bis(fluorosulfonyl)imide anion, and bis(fluorosulfonate)imide anion,
a sum of a content of alkali metal and a content of alkaline-earth metal in the conductive elastic layer being 1.0×10⁻⁶ mol/g or less,
the manufacturing method comprising:
a step of pouring an elastic layer forming material into a mold with the substrate disposed therein; and
a step of heating the mold and curing the elastic layer forming material to form the conductive elastic layer, wherein
the elastic layer forming material comprises at least a liquid composition comprising an ion compound represented by Structural Formula (7) below, polyol, and polyisocyanate,
a content of the ion compound in the liquid composition is 95% by mass or more and less than 100% by mass,
a content of alkali metal and alkaline-earth metal in the liquid composition is 30000 ppm or less, and
a viscosity of the liquid composition at 23 °C is 1 to 1000 mPa·s: 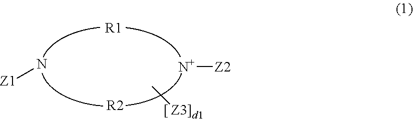
where in Structural Formula (1), R1 and R2 represent a hydrocarbon group needed to form a nitrogen-containing heteroaromatic 5-membered ring together with a nitrogen atom to which each of R1 and R2 is bonded, and d1 represents an integer which is 0 or 1. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, at least one of Z1 to Z3 is the structure represented by Structural Formula (Z101) below, the structure represented by Structural Formula (Z102) below, or the structure represented by Structural Formula (Z103) below: 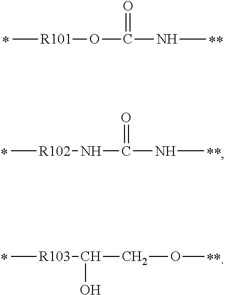
where in Structural Formulas (Z101), (Z102), and (Z103), R101, R102, and R103 each independently represent a linear or branched divalent hydrocarbon group. The symbol “*” represents a bonding portion with a nitrogen atom or a carbon atom constituting the nitrogen-containing heteroaromatic 5-membered ring of the Structural Formula (1). The symbol “**” represents a bonding portion with a carbon atom in a polymer chain of the polyurethane: 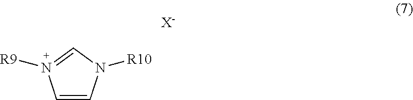
where in Structural Formula (7), R9 and R10 each independently represent an alkyl group having 1 to 4 carbon atoms, a hydroxyalkyl group having 1 to 4 carbon atoms, or a hydrogen atom. At least one of R9 and R10 is a hydroxyalkyl group having 1 to 4 carbon atoms. X⁻ represents an anion.

9. A process cartridge configured to be attachable to and detachable from a main body of an electrophotographic image forming apparatus, the process cartridge comprising:
a contact member that is electrically connected to an electrical contact point of the main body when the process cartridge is attached to the main body;
a developing roller; and a developer supply roller that supplies a developer to the developing roller, wherein
the process cartridge is configured such that a voltage is able to be applied between the developing roller and the developer supply roller through electrical connection to the main body,
the developer supply roller is a conductive elastic roller comprising
a conductive substrate, and a conductive elastic layer on the substrate, wherein
the conductive elastic layer comprises polyurethane comprising a urethane bond and an ether bond, and an anion,
the polyurethane comprises at least one selected from the group consisting of a cationic structure represented by Structural Formula (1) below, a cationic structure represented by Structural Formula (2) below, and a cationic structure represented by Structural Formula (3) below,
the anion comprises at least one selected from the group consisting of (fluorosulfonyl)imide anion, (fluorosulfonate)imide anion, fluoroborate anion, fluorophosphate anion, dicyanamide anion, and thiocyanate anion, and
a sum of a content of alkali metal and a content of alkaline-earth metal in the conductive elastic layer is 1.0×10⁻⁶ mol/g or less: 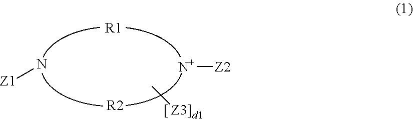
where in Structural Formula (1), R1 and R2 represent a hydrocarbon group needed to form a nitrogen-containing heteroaromatic 5-membered ring together with a nitrogen atom to which each of R1 and R2 is bonded, and d1 represents an integer which is 0 or 1. Z1 to Z3 each independently represent a structure represented by Structural Formula (Z101) below, a structure represented by Structural Formula (Z102) below, a structure represented by Structural Formula (Z103) below, a hydrogen atom, or a hydrocarbon group having 1 to 4 carbon atoms. However, at least one of Z1 to Z3 is the structure represented by Structural Formula (Z101) below, the structure represented by Structural Formula (Z102) below, or the structure represented by Structural Formula (Z103) below: 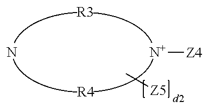
where in Structural Formula (2), R3 and R4 represent a hydrocarbon group needed to form a nitrogen-containing heteroaromatic 6-membered ring together with a nitrogen atom to which each of R3 and R4 is bonded, d2 represents an integer which is from 0 to 2, and Z5 may be the same or differ when d2 is 2. Z4 and Z5 each independently represent the structure represented by Structural Formula (Z101) below, the structure represented by Structural Formula (Z102), the structure represented by Structural Formula (Z103), a hydrogen atom, or a hydrocarbon group having 1 to 4 carbon atoms. However, at least one of Z4 and Z5 is the structure represented by Structural Formula (Z101) below, the structure represented by Structural Formula (Z102) below, or the structure represented by Structural Formula (Z103) below: 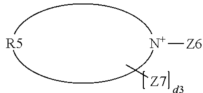
where in Structural Formula (3), R5 represents a hydrocarbon group needed to form a nitrogen-containing heteroaromatic ring together with a nitrogen atom to which R5 is bonded, and d3 represents an integer which is 0 or 1. Z6 and Z7 each independently represent the structure represented by Structural Formula (Z101) below, the structure represented by Structural Formula (Z102) below, the structure represented by Structural Formula (Z103) below, a hydrogen atom, or a hydrocarbon group having 1 to 4 carbon atoms. However, at least one of Z6 and Z7 is the structure represented by Structural Formula (Z101) below, the structure represented by Structural Formula (Z102) below, or the structure represented by Structural Formula (Z103) below: 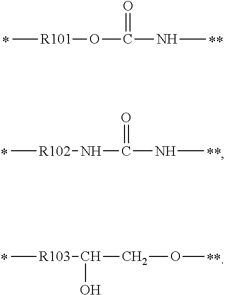
where in Structural Formulas (Z101), (Z102), and (Z103), R101, R102, and R103 each independently represent a linear or branched divalent hydrocarbon group. The symbol “*” represents a bonding portion with a nitrogen atom or a carbon atom constituting the nitrogen-containing heteroaromatic 5-membered ring of Structural Formula (1), a bonding portion with a nitrogen atom or a carbon atom constituting the nitrogen-containing heteroaromatic 6-membered ring of Structural Formula (2), or a bonding portion with a nitrogen atom or a carbon atom constituting the nitrogen-containing heteroaromatic ring of Structural Formula (3). The symbol “**” represents a bonding portion with a carbon atom in a polymer chain of the polyurethane.

10. An electrophotographic image forming apparatus comprising at least:
an electrophotographic photosensitive member;
a developing roller that is disposed in contact with the electrophotographic photosensitive member; and
a developer supply roller that supplies a developer to the developing roller, wherein
the developer supply roller is the conductive elastic roller according to claim 1.
